(19) United States
(12) Patent Application Publication
(10) Pub. No.: US 2019/0307146 A1
(43) Pub. Date: Oct. 10, 2019

(54) METHOD FOR PRODUCING AROMA COMPOSITION FROM ROASTED COFFEE BEANS AND APPARATUS FOR COLLECTING AROMA FROM ROASTED COFFEE BEANS

(71) Applicant: T. HASEGAWA CO., LTD., Tokyo (JP)

(72) Inventors: Koji MURAI, Nakahara-ku, Kawasaki-shi, Kanagawa (JP); Yoshiyuki MISUMI, Nakahara-ku, Kawasaki-shi, Kanagawa (JP); Takeshi WATANABE, Nakahara-ku, Kawasaki-shi, Kanagawa (JP); Takayuki KANEKO, Fukaya-shi, Saitama (JP)

(21) Appl. No.: 16/468,983

(22) PCT Filed: Dec. 13, 2017
(86) PCT No.: PCT/JP2017/044665

§ 371 Date: Jun. 12, 2019

(30) Foreign Application Priority Data
Dec. 16, 2016 (JP) 2016-244867

(51) Int. Cl. A23F 5/48; A23L 27/10; B01D 53/04; B01D 53/12; B01J 20/10; B01J 20/26; B01J 20/34

(52) U.S. Cl. CPC A23F 5/486; A23L 27/10; B01D 53/04; B01J 20/34; B01J 20/10; B01J 20/261; B01D 53/12

(57) ABSTRACT

A method for producing an aroma composition from roasted coffee beans, including grinding roasted coffee beans to give a crude ground powder of roasted coffee beans that contains a fine powder and thin flakes, removing the fine powder and thin flakes from a gas that contains aroma compounds emitted from the roasted coffee beans in grinding the roasted coffee beans and the fine powder and thin flakes, introducing the gas from which the fine powder and thin flakes have been removed into an adsorbent to thereby make the aroma compounds adsorbed by the adsorbent, and collecting the aroma compounds from the adsorbent to prepare an aroma composition containing the aroma compounds. The adsorbent is held in an adsorbent holder in an aroma compound adsorbing device, and the adsorbent holder has a mesh lid at both ends thereof in the gas flowing direction therethrough.

### TECHNICAL FIELD

The present invention relates to a method for producing an aroma composition from roasted coffee beans and to an apparatus for collecting aroma from roasted coffee beans.

### BACKGROUND ART

An aroma composition is used as a food flavoring or a fragrance. An aroma composition for food and drink can be prepared from a natural flavoring, a synthetic chemical for flavorings and/or a blended composition for flavorings composed of the former two, and with the recent tendency toward consumer needs for natural feeling, a flavoring is also desired to be a natural flavoring or a flavoring having a feel of nature, and various production methods are now under investigation.

For a coffee flavoring, at present, various production methods are employed. For example, various methods are known as a method for producing a flavoring composition from roasted coffee beans (see PTL 1).

Specifically, for example, PTL 1 describes a method for producing a coffee flavoring by trapping a volatile coffee flavor component-containing vapor that has been released by introducing a steam and/or an inert gas toward a ground roasted coffee, in a solution of caramel or the like; a method of fractionating a condensed water obtained by steam distillation of roasted coffee; a method of bringing a flavor component-containing distillation liquid obtained through distillation of fruit juice or coffee into contact with a reversed-phase partition-type adsorbent followed by extracting it with a solvent; a method for formulating a coffee flavoring having both an aroma component and a taste component, which contains a coffee flavor raw material obtained in a steam distillation in an aqueous layer and contains a coffee oil obtained in expressed oil collection or supercritical fluid extraction as an oil phase; and a method for producing a tea flavoring by bringing a distillate obtained through steam distillation of tea leaves into contact with tea leaves to remove the heating distillation smell from the tea distillate.

According to PTL 1, the steam distillation method is a method where a steam vapor is applied to a raw material and the aroma component to evaporate along with the steam is condensed with the steam, and depending on the type of the raw material to be processed, any distillation method of increased pressure steam distillation, atmospheric steam distillation or reduced pressure steam distillation is employable for the method, as so described therein.

Among coffee flavorings, in particular, a flavoring capable of giving freshly ground aroma has been desired for long periods. Given the situation, methods of using aroma that is emitted in grinding roasted coffee beans have been proposed (PTLs 2 to 6).

### CITATION LIST

### Patent Literature

PTL 1: JP 2003-33137 A

PTL 2: JP 3719995 B1

PTL 3: JP 4182471 B1

PTL 4: JP 4308724 B1

PTL 5: JP 4745591 B1

PTL 6: JP 2003-144053 A

### SUMMARY OF INVENTION

### Technical Problem

In the methods described in PTLs 2 to 5, the gas that contains an aroma component emitted in grinding roasted coffee beans (grinding gas) is directly introduced into a solvent, water or a coffee oil, to produce an aroma composition.

In the method of PTL 6, the gas from grinding roasted coffee beans is compressed under pressure and stored in an aluminum container.

However, for the aroma compositions to be obtained according to the methods described in PTLs 2 to 6, the collecting efficiency is not high since the aroma compound-containing gas is made to flow through a solvent, and the compositions could not sufficiently reproduce the fresh flavor in grinding roasted coffee beans.

In addition, the methods described in PTLs 2 to 6 use an inert gas and require special devices such as closed grinding machines, passages to solvent layers, as well as solvent layers and constant-temperature tanks, therefore increasing the capital investment and making it difficult to put them into practical use.

An object of the present invention is to provide a method for producing an aroma composition from roasted coffee beans using an ordinary grinding machine and capable of being put into practical use without requiring any great capital investment and serious load on equipments, and the aroma composition thus produced according to the method can give an aroma that is emitted in grinding roasted coffee beans, that is, such a fresh aroma to be emitted in just grinding roasted coffee beans.

Another object of the present invention is to provide an apparatus for collecting aroma from roasted coffee beans, which, using an ordinary grinding machine, can be put into practical use without requiring any additional great capital investment and serious load on equipments and can produce an aroma composition capable of giving an aroma that is perceivable in grinding roasted coffee beans.

### Solution to Problem

The present inventors have made assiduous studies for the purpose of solving the above-mentioned problems, and, as a result, have found that, as a method wholly different from the methods described in PTLs 1 to 6, when, from a gas that contains aroma compounds that are emitted from roasted coffee beans in grinding roasted coffee beans, thin flakes or a fine powder of chaff, an excessively finely ground powder of coffee beans, and thin flakes and a fine powder derived from any other foreign substances (hereinafter these are collectively referred to as “fine powder and thin flakes”), the fine powder and thin flakes are removed, and thereafter the aroma compounds that are emitted in grinding roasted coffee beans are adsorbed by an adsorbent and collected, then the aroma compounds can be effectively collected and a natural aroma composition capable of giving an aroma that is emitted in grinding roasted coffee beans can be produced efficiently without forcedly requiring any further great capital investment over an ordinary grinding apparatus (for example, a conventional grinding apparatus), and have completed the present invention.

The present invention as a specific means for solving the above-mentioned problems and preferred embodiments thereof are as described below.

[1] A method for producing an aroma composition from roasted coffee beans, which includes:

a step of grinding roasted coffee beans to give a crude ground powder of roasted coffee beans, the crude ground powder containing a fine powder and thin flakes, and includes:

a step of removing the fine powder and thin flakes from a gas that contains aroma compounds emitted from the roasted coffee beans in grinding the roasted coffee beans and contains the fine powder and thin flakes,

an adsorption step of introducing the gas from which the fine powder and thin flakes have been removed into an adsorbent to thereby make the aroma compounds adsorbed by the adsorbent, and

a collection step of collecting the aroma compounds from the adsorbent to prepare an aroma composition containing the aroma compounds, and in which:

the adsorbent is held in an adsorbent holder in an aroma compound adsorbing device, and the adsorbent holder has a mesh lid at both ends thereof in the gas flowing direction therethrough.

[2] The method for producing an aroma composition from roasted coffee beans according to [1], wherein a step of removing the fine powder and thin flakes from the crude ground powder of roasted coffee beans is carried out prior to the step of removing the fine powder and thin flakes from the gas.
[3] The method for producing an aroma composition from roasted coffee beans according to [1] or [2], wherein the step of removing the fine powder and thin flakes is carried out in a fine powder and thin flakes removing device.
[4] The method for producing an aroma composition from roasted coffee beans according to any one of [1] to [3], wherein the gas flow is generated using a gas flow generating device.
[5] The method for producing an aroma composition from roasted coffee beans according to any one of [1] to [4], wherein: in a flow channel for the gas from which the fine powder and thin flakes have been removed, a guide path that branches from the flow channel and is communicated with the aroma compound adsorbing device is provided, and only a part of the gas from which the fine powder and thin flakes have been removed is made to flow through the guide path and the adsorbent to collect the aroma compounds.
[6] The method for producing an aroma composition from roasted coffee beans according to any one of [1] to [5], wherein the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel.
[7] The method for producing an aroma composition from roasted coffee beans according to any one of [1] to [6], wherein the aroma compounds are desorbed from the adsorbent using an organic solvent in the collecting step.
[8] The method for producing an aroma composition from roasted coffee beans according to [7], wherein the organic solvent is ethanol or propylene glycol.
[9] The method for producing an aroma composition from roasted coffee beans according to any one of [1] to [8], wherein the linear speed of the gas flowing into the adsorbent is within a range of 0.1 to 35.0 m/s.
[10] The method for producing an aroma composition from roasted coffee beans according to any one of [1] to [9], wherein the gas flowing direction is substantially an opposite direction to the direction of gravitational force.
[11] The method for producing an aroma composition from roasted coffee beans according to any one of [1] to [10], wherein the aroma compound adsorbing device is a fluidized-bed column that holds the adsorbent therein.
[12] The method for producing an aroma composition from roasted coffee beans according to any one of [1] to [11], which includes a step of controlling the linear speed of the gas flowing into the adsorbent.
[13] The method for producing an aroma composition from roasted coffee beans according [12], wherein the linear speed of the gas flowing into the adsorbent is controlled using a blower or a suction pump.
[14] A food or drink containing an aroma composition produced according to the production method of any one of [1] to [13].
[15] An apparatus for collecting aroma from roasted coffee beans, which includes:

a device for grinding roasted coffee beans,

a first flow channel which is communicated with the grinding device and through which a gas can flow, the gas containing aroma compounds emitted in grinding the roasted coffee beans and containing a fine powder and thin flakes,

a fine powder and thin flakes removing device communicated with the first flow channel,

a second flow channel which is communicated with the fine powder and thin flakes removing device and through which the gas, from which a fine powder and thin flakes have been removed, can flow,

an aroma compound adsorbing device communicated with the second flow channel, and

a gas flow generating device that generates a gas flow continuing from the grinding device to the aroma compound adsorbing device, and in which:

the aroma compound adsorbing device has an adsorbent holder that holds an adsorbent therein, and the adsorbent holder has a mesh lid at both ends thereof in the gas flowing direction therethrough.

[16] The apparatus for collecting aroma from roasted coffee beans according to [15], which further includes a guide path branched from the second flow channel, and in which the guide path is communicated with the aroma compound adsorbing device.
[17] The apparatus for collecting aroma from roasted coffee beans according to [15] or [16], which further includes a fine powder and thin flakes preremoving device between the grinding device and the first flow channel.
[18] The apparatus for collecting aroma from roasted coffee beans according to any one of [15] to [17], wherein the gas flowing direction through the adsorbent is substantially an opposite direction to the direction of gravitational force.
[19] The apparatus for collecting aroma from roasted coffee beans according to any one of [15] to [18], wherein the aroma compound adsorbing device is a fluidized-bed column that holds the adsorbent therein.
[20] The apparatus for collecting aroma from roasted coffee beans according to any one of [15] to [19], which further includes a linear speed controlling device for controlling the linear speed of the gas from which the fine powder and thin flakes have been removed.
[21] The apparatus for collecting aroma from roasted coffee beans according to any one of [15] to [20], wherein the linear speed controlling device is a blower or a suction pump.
[22] The apparatus for collecting aroma from roasted coffee beans according to any one of [15] to [21], wherein the diameter of the cross section of the adsorbent part held in the adsorbent holder is 10 mm or more.
[23] The apparatus for collecting aroma from roasted coffee beans according to any one of [15] to [22], wherein the length in the gas flowing direction of the adsorbent part held in the adsorbent holder is 1000 mm or less.

### Effects of Invention

According to the present invention, there can be provided a method for producing an aroma composition from roasted coffee beans using an ordinary grinding machine without requiring any additional great capital investment and serious load on equipments, and the aroma composition thus produced according to the method can give an aroma that is emitted in grinding roasted coffee beans, that is, such a fresh aroma that is perceivable in grinding roasted coffee beans.

The aroma composition obtained according to the production method of the present invention is, though being a natural flavoring, able to enhance the top aroma derived from roasted coffee beans. Preferably, the aroma composition obtained according to the production method of the present invention gives at the top a fresh aroma that is perceivable in grinding roasted coffee beans, and preferably additionally gives a mild and voluminous flavor to coffee-taste food and drink or enhances such a flavor in the middle and later (that is, from the middle to the last).

Also according to the present invention, there can be provided an apparatus for collecting aroma from roasted coffee beans, which, using an ordinary grinding machine and without requiring any additional great capital investment and serious load on equipments, can produce an aroma composition capable of giving an aroma that is perceivable in grinding roasted coffee beans.

### BRIEF DESCRIPTION OF DRAWINGS

FIG. 1 is a schematic view showing an example of an aroma collecting apparatus of the present invention.

FIG. 2 is a schematic view showing another example of an aroma collecting apparatus of the present invention.

FIG. 3 is a cross-sectional schematic view of an adsorbent holder in the present invention.

FIG. 4 is a performance diagram of an ordinary gas flow generator.

FIG. 5 is one example of a total ion chromatogram of an aroma composition of a invention product 1.

FIG. 6 is one example of a total ion chromatogram of an aroma composition of a comparative product 3.

### DESCRIPTION OF EMBODIMENTS

The present invention is described in detail hereinunder. The description of the constitutive elements of the invention given hereinunder is for some typical embodiments or examples of the invention, to which, however, the invention should not be limited. In this description, the numerical range expressed by the wording “a number to another number” means the range that falls between the former number indicating the lower limit of the range and the latter number indicating the upper limit thereof.

[Method for Producing Aroma Composition from Roasted Coffee Beans]

The method for producing an aroma composition from roasted coffee beans of the present invention (hereinafter this may be referred to as the production method of the present invention) includes a step of grinding roasted coffee beans to give a crude ground powder of roasted coffee beans, the crude ground powder containing a fine powder and thin flakes, and includes:

a step of removing the fine powder and thin flakes from a gas that contains that are emitted from the roasted coffee beans in grinding the roasted coffee beans and contains the fine powder and thin flakes,

an adsorbing step of introducing the gas from which the fine powder and thin flakes have been removed into an adsorbent to thereby make the aroma compounds adsorbed by the adsorbent, and

a collecting step of collecting the aroma compounds from the adsorbent to prepare an aroma composition containing the aroma compounds, and in which:

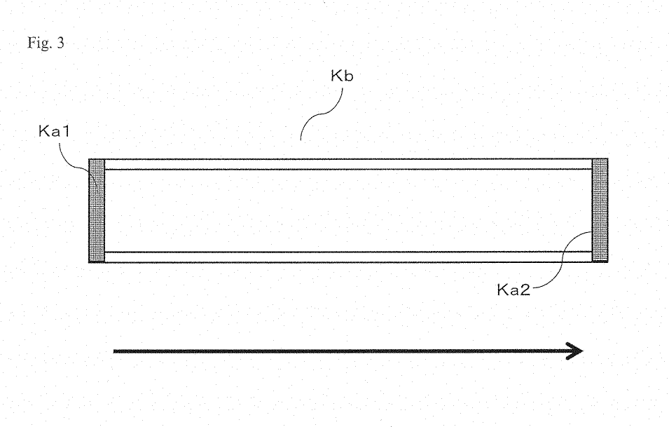

the adsorbent is held in an adsorbent holder in an aroma compound adsorbing device, and the adsorbent holder has a mesh lid at both ends thereof in the gas flowing direction therethrough (see FIG. 3, the arrow in the drawing indicates the gas flowing direction).

The details of the mesh lid are described below.

According to the above-mentioned constitution, an aroma composition that gives an aroma that is emitted in grinding roasted coffee beans can be produced from roasted coffee beans using an ordinary grinding device and without requiring any additional great capital investment and serious load on equipments. Further, it is preferable to produce an aroma composition from roasted coffee beans, which gives at the top a fresh aroma that is perceivable in grinding roasted coffee beans, and also gives a mild and voluminous and flavor and aftertaste to coffee-taste food and drink or enhances such a flavor in the middle and later.

A coffee bean (raw bean) is a seed part of a coffee cherry, and a thin skin called a silver skin adheres to the coffee bean. A roasted coffee bean has an astringent chaff adhering thereto, which is a roasted matter of the silver skin. When roasted coffee beans are ground into a desired size, in addition to a ground powder of coffee bean bodies ground into a desired size, there are formed thin flakes and a ground powder of chaff, an excessively finely ground powder of coffee bean bodies, thin flakes and a fine powder derived from any other foreign substances (in this description, these are collectively referred to as “fine powder and thin flakes”), and the fine powder and thin flakes are light and scatter. In industrial grinding of roasted coffee beans, at least a part of the fine powder and thin flakes scatter and mix in an exhaust gas flow generated in the grinding device. Heretofore, the exhaust gas flow has been discharged out of the device as it is, after the fine powder and thin flakes have been appropriately removed therefrom.

Here, in the present invention, differing from PTLs 2 to 6, an adsorbent held in an aroma compound adsorbing device is used in place of a solvent (liquid) for collecting aroma compounds. If an exhaust gas flow containing a fine powder and thin flakes therein is, as it is, directly introduced into an adsorbent, it is considered that the fine powder and thin flakes may clog a mesh lid and may also clog fine pores of an adsorbent and even fine voids between adsorbent particles to make the exhaust gas flow difficultly flow therethrough so that the exhaust system of the grinding device (exhaust ventilation by the gas flow generating device to be mentioned below in the present invention) will be overloaded (pressured). As opposed to this, the production method of the present invention employs a method where, after a fine powder and thin flakes have been removed from the exhaust gas flow, the resultant exhaust gas flow is introduced into an adsorbent to make the adsorbent adsorb aroma compounds, and according to the production method of the present invention, therefore, aroma compounds contained in the exhaust gas flow can be adsorbed by the adsorbent with no risk of clogging of the mesh lid and the adsorbent and no risk of giving a load on the device. In addition, owing to this clogging prevention, the aroma compounds can be efficiently adsorbed by the adsorbent.

Referring to exhaust system performance of an ordinary grinding device, when an adsorbent is held in an adsorbent holder arranged in the flow channel of an exhaust gas flow in the device, a load over an allowable range may be given to the device owing to the resistance of the adsorbent to the exhaust gas flow (in this description, this may be simply referred to as a load). Consequently, in the present invention, a means of suppressing the resistance owing to the adsorbent may be employed. For example, the length in the flowing direction of an exhaust gas flow (also referred to as the gas flowing direction) in the part occupied by the adsorbent held in the adsorbent holder (hereinafter in this description, this may be referred to as an adsorbent part, or a held adsorbent part) is reduced, or a flow channel that is branched from the flow channel of an exhaust gas flow and holds an adsorbent therein is arranged so as to collect aroma compounds from a part of the exhaust gas flow. Apart from these exemplifications, the resistance of adsorbent may also be suppressed by enhancing the mobility of the adsorbent held in the device (for example, using a so-called “fluidized-bed column”). Further, a blower or a suction pump may be additionally used for the gas introduction into the adsorbent over the resistance thereof.

Preferred embodiments of the production method of the present invention are described below.

### <Step of Preparing Crude Ground Powder of Roasted Coffee Beans>

The production method of the present invention includes a step of grinding roasted coffee beans to give a crude ground powder of roasted coffee beans, wherein the crude ground powder contains a fine powder and thin flakes.

Preferably, the step of grinding roasted coffee beans to give a crude ground powder of roasted coffee beans is carried out prior to any other step.

The method of grinding roasted coffee beans is not specifically limited, and any known method is employable. For example, any known grinding device such as a roller mill, a jet mill, a hammer mill, a rotary mill, or a shaking mill may be employed.

Not specifically limited, the grinding speed for roasted coffee beans may be, for example, 1 to 500 kg/h.

Also not specifically limited, the grinding size of roasted coffee beans may be on any level of so-called fine grind, medium-fine grind or coarse grind, and may be the same as a known preferred size range. For example, the size may be 0.2 to 3 mm or so.

### (Roasted Coffee Beans)

The roasted coffee beans for use in the production method of the present invention are not specifically limited. Not adhering to any theory, it is presumed that the kind of coffee beans and the roasting degree of coffee may mainly influence the mass ratio of the aroma compounds having a large molecular weight in an aroma composition. The aroma of an aroma composition that is emitted in grinding roasted coffee beans is an aroma at the top (arising from a volatile aroma compound(s) having a small molecular weight), and therefore it is presumed that the kind of coffee beans and the coffee roasting degree would have little influence on the aroma. Consequently, the present invention is applicable to multi-purpose utilization, not depending on the kind and the roasting degree of coffee beans.

The coffee beans for use in the production method of the present invention may be, for example, any of Arabica coffee, Robusta coffee, or Liberica coffee, and any coffee beans are employable herein irrespective of kind and production area thereof. Raw coffee beans may be roasted in any ordinary method using a coffee roaster or the like. For example, raw coffee beans are put into a rotary drum, and with rotating the rotary drum for stirring, the beans may be heated from the below with a gas burner or the like to be roasted. The roasting degree is generally expressed by L value, 16 to 19 for Italian roast; 19 to 21 for French roast; 21 to 23 for Full city roast; 23 to 25 for City roast; 25 to 27 for High roast; and 27 to 29 for Medium roast. Softer roasting than these is not so much used for ordinary coffee. The L value is an index that indicates the degree of coffee roasting, and is a value of the lightness of a ground powder of roasted coffee beans measured with a colorimeter. Black is represented by an L value 0, and white is by 100. Accordingly, harder roasted coffee beans have a lower value, and softer roasted coffee beans have a higher value.

The kind of coffee beans, the roasting method for coffee beans and the treatment method for roasted coffee beans are not specifically limited. For example, the methods described in [0015] to [0027] in JP 2013-252112 A, and [0021] to [0024] in JP 2015-149950 A may be employed. The contents of these patent publications are incorporated herein by reference.

### (Crude Ground Powder of Roasted Coffee Beans)

Preferably, the crude ground powder of roasted coffee beans contains the above-mentioned fine powder and thin flakes, and a ground powder of roasted coffee bean bodies ground into a desired size.

Preferably, the fine powder and thin flakes are removed from the gas that contains aroma compounds that are emitted from roasted coffee beans in grinding the roasted coffee beans. Specifically, it is preferable that the fine powder and thin flakes pass through a first flow channel to be mentioned in detail hereinunder, along with the gas, and are removed from the gas in a fine powder and thin flakes removing device.

### (Aroma Compound Emitted in Grinding Roasted Coffee Beans)

The aroma compound that is emitted from roasted coffee beans in grinding the roasted coffee beans includes one or plural compounds. This is specifically described in the section of the aroma composition to be given hereinunder.

### <Step of Preremoving Fine Powder and Thin Flakes>

In the production method of the present invention, preferably, a step of removing a fine powder and thin flakes from the crude ground powder of roasted coffee beans is carried out prior to the step of removing a fine powder and thin flakes from the gas mentioned above. The fine powder and thin flakes may be removed partly, but substantially the whole thereof may be removed. Also, a fine powder and thin flakes derived from any others than chaff may be mainly removed, or a fine powder and thin flakes derived from chaff may be removed at least partly in the preremoving step, or almost all thereof may not be removed.

The step of removing a fine powder and thin flakes from the crude ground powder of roasted coffee beans may be carried out using any known fine powder and thin flakes removing device, for example, a classification device such as a shaking sieve or a wind classification device. A classification device using a shaking sieve is preferred. For example, using a sieve having a desired opening, a fine powder and thin flakes smaller than the opening may be removed.

### <Step of Removing Fine Powder and Thin Flakes>

The production method of the present invention includes a step of removing a fine powder and thin flakes from a gas that contains aroma compound that are emitted from roasted coffee beans in grinding roasted coffee beans and contains a fine powder and thin flakes. Not removed, the fine powder and thin flakes may partly remain, but preferably, the fine powder and thin flakes are removed substantially wholly. Regarding the fine powder and thin flakes to be removed in the removing step, those derived from chaff may occupy at least a half of the fine powder and thin flakes, or all the fine powder and thin flakes to be removed therein may be substantially those derived from chaff.

The step of removing a fine powder and thin flakes is not specifically limited, and may be carried out in any known method.

In the production method of the present invention, preferably, the step of removing a fine powder and thin flakes is carried out in a fine powder and thin flakes removing device to be mentioned in detail hereinunder.

The details of the fine powder and thin flakes removing device are given in the section of the aroma collecting apparatus of the present invention.

### <Adsorbing Step>

The production method of the present invention includes an adsorbing step of introducing the gas from which a fine powder and thin flakes have been removed into an adsorbent to thereby make the aroma compounds that are contained in the gas adsorbed by the adsorbent. Here, the adsorbent is held in an adsorbent holder arranged in an aroma compound adsorbing device, and the adsorbent holder has a mesh lid at both ends thereof in the gas flowing direction therethrough.

The adsorbent amount may be, not specifically limited, an amount capable of being held in the adsorbent holder. The volume (bulk volume) of the adsorbent to be used may be the same as the volume of the adsorbent holder, or may be less than it. In other words, the adsorbent may be filled (roughly filled or densely filled) in the adsorbent holder, or there may exist some void space in the adsorbent holder that holds an adsorbent therein.

The gas flowing direction may be at any desired angle relative to the installation surface on which the aroma collecting apparatus is installed (or the ground plane in the case where the aroma collecting apparatus is installed on the ground), and may be, for example, parallel or vertical thereto. Also, for example, the gas flowing direction may be the direction approaching to or leaving from the installation surface of the aroma collecting apparatus. In other words, the gas flowing direction through the adsorbent may be a substantially opposite direction to the direction of gravitational force, or substantially the same direction thereto, or may be perpendicular thereto, or may be at any other angle thereto. In the case where the gas is made to flow into or through the adsorbent in a substantially opposite direction to the direction of gravitational force, the volume (bulk volume) of the adsorbent to be used may be smaller than the volume of the adsorbent holder so that the aroma compound adsorbing device may be a so-called fluidized-bed column and the resistance of the adsorbent to the gas flow may be thereby reduced.

In the production method of the present invention, preferably, a gas flow is generated using a gas flow generating device and the gas from which a fine powder and thin flakes have been removed is introduced into the adsorbent. Using both a flow rate controlling device and a gas flow generating device, the gas flow rate and pressure may be increased. By the combined use, the gas may be made to flow exceeding the resistance of the adsorbent to the gas flow.

The details of the gas flow generating device and the gas flow rate controlling device are described in the section of the aroma collecting apparatus of the present invention given hereinunder.

In the production method of the present invention, preferably, a guide path having an adsorbent arranged therein may be so arranged as to be branched from the flow channel of the gas from which a fine powder and thin flakes have been removed, so that only a part of the gas from which a fine powder and thin flakes have been removed could be made to flow into or through the guide path and further to flow through the adsorbent to thereby collect aroma compounds.

The details of the guide path are described in the section of the aroma collecting apparatus of the present invention.

### (Adsorbent)

The adsorbent is not specifically limited. As the adsorbent, a synthetic adsorbent or an activated carbon and any other adsorbent are employable. Preferably, a synthetic adsorbent is used from the viewpoint that it is readily desorbable.

Preferably, the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel. The modified silica gel is a chemically-bonded silica gel prepared by chemically bonding a reactive substance such as an alcohol, an amine, a silane or the like to the surface of a silica gel by utilizing the reactivity of the silanol group with the reactive substance. Above all, a styrene-divinylbenzene copolymer is preferred.

The adsorbent is preferably a porous polymer resin. The surface area of the adsorbent is, for example, preferably about 300 m²/g or more, more preferably about 500 m²/g or more. Also preferably, the pore size distribution of the adsorbent is about 10 Å to about 500 Å.

Not specifically limited, the shape of the adsorbent is granular. Also not specifically limited, the average particle diameter of the granular adsorbent may be, for example, within a range of 0.1 to 20 mm, or 0.1 to 1 mm.

Examples of the porous polymer resin satisfying the above-mentioned requirements include an HP resin (manufactured by Mitsubishi Chemical Corporation), an SP resin of a styrene-divinylbenzene copolymer (manufactured by Mitsubishi Chemical Corporation), and XAD-4 (manufactured by Rohm & Haas Inc.), and these are readily available on the market. Also commercial products of a methacrylate resin, for example, XAD-7 and XAD-8 (manufactured by Rohm & Haas Inc.) are also available.

Preferred examples of the SP resin include Sepabeads SP-70 and SP-207.

The processing means for introducing the gas from which a fine powder and thin flakes have been removed into the adsorbent so as to make aroma compounds adsorbed by the adsorbent may be any of a batch system or a column system. From the viewpoint of workability, a column system is preferably employed. Regarding adsorbing method using a column system device, for example, the gas is introduced into a column filled with the above-mentioned adsorbent so that aroma compounds may be adsorbed by the adsorbent. The direction of the gas flowing into and through the adsorbent may be any desired direction relative to the direction of gravitational force, and for example, though not limited thereto, the direction may be substantially the same direction as or substantially an opposite direction to the direction of gravitational force.

By controlling the particle size and the amount of the adsorbent, the adsorbent holder may be made to have some void space therein, and further, the gas may be made to flow thereinto or therethrough in a substantially opposite direction to the direction of gravitational force, like in a fluidized-bed column.

For preventing it from cracking, preferably, the adsorbent is made to absorb pure water and, before being completely dried, it is held in the aroma compound adsorbing device.

The gas flow amount in introducing the gas from which a fine powder and thin flakes have been removed into the adsorbent is, though not specifically limited thereto, for example, preferably 0.1 to 1000 times by volume of the adsorbent.

Not specifically limited, the flow rate of the gas to flow through the adsorbent (the flowing gas speed) may be appropriately set depending on the adsorbent amount, the length in the gas flowing direction of the adsorbent part, and the performance of the gas flow generating device and the flow rate controlling device to be mentioned hereinunder. For example, the gas flow rate (flowing gas speed) of the gas flowing into the adsorbent is preferably 0.1 to 10.0 L/min, more preferably 0.5 to 7.0 L/min, and even more preferably 1.0 to 5.0 L/min.

A preferred range of the gas introduction time into the adsorbent may be set depending on the gas flow amount in introducing the gas from which a fine powder and thin flakes have been removed into the adsorbent and on the flow rate of the gas introduced into the adsorbent.

In the production method of the present invention, the flow rate (linear speed) of the gas flowing into the adsorbent may be appropriately set depending on the adsorbent amount, the length of the gas flowing direction in the adsorbent part, the inner diameter of the second flow channel to be mentioned hereinunder, and the performance of the gas flow generating device and the flow rate controlling device also to be mentioned hereinunder, and is not specifically limited. For example, the flow rate is preferably within a range of 1.0 to 35.0 m/s, more preferably within a range of 2.0 to 20.0 m/s, and even more preferably within a range of 3.0 to 10.0 m/s.

### <Step of Controlling Gas Linear Speed>

Preferably, the production method of the present invention includes a step of controlling the linear speed of the gas flowing into the adsorbent, from the viewpoint of realizing adsorbability over the resistance of the adsorbent and from the viewpoint of reducing the load on the gas flow generating device to be mentioned hereinunder, even when a large amount of an adsorbent is held (or filled) in the aroma compound adsorbing device.

In the production method of the present invention, the linear speed of the gas to flow into the adsorbent may be controlled using any known gas flow generating device, for example, a suction pump or a blower.

For example, the linear speed of the gas flowing into the adsorbent may be in any desired ratio relative to the linear speed of the gas flowing through the second flow channel, and relative to the upper limit referred to as 100%, the linear speed may be 90% or more, 80% or more, 70% or more, 60% or more, 50% or more, 40% or more, 30% or more, 20% or more, 10% or more, 5% or more, or even 1% or more. Concretely, the range includes 0.05 to 35 m/s, 0.08 to 20 m/s, 1.0 to 10 m/s, 1.0 to 5 m/s, or 1.0 to 2 m/s, but is not specifically limited thereto.

For example, preferably, the ratio of the linear speed of the gas flowing into the adsorbent relative to the linear speed of the gas flowing into the second flow channel is controlled in accordance with the performance of the gas flow generating device to be mentioned below. According to such controlling, the load on the gas flow generating device can be reduced.

### <Collecting Step>

The production method of the present invention includes a collecting step of collecting aroma compounds from the adsorbent to prepare an aroma composition containing the aroma compounds.

The collecting step is preferably a step of collecting aroma compounds from the adsorbent to prepare a solution containing the aroma compounds.

In the production method of the present invention, aroma compounds are preferably desorbed from the adsorbent using an organic solvent and collected in the collecting step. More preferably, in the collecting step, aroma compounds are desorbed from the adsorbent using propylene glycol or ethanol as a desorbent, and the resultant propylene glycol solution or ethanol solution is obtained as a coffee flavor improver. Also the propylene glycol solution or ethanol solution may be diluted appropriately, and the resultant dilutions may be used as an aroma composition, or the propylene glycol and the ethanol solution may be mixed to give a mixture serving as an aroma composition. In this description, propylene glycol and ethanol may be referred to as a desorbent or solvent.

Before desorbing aroma compounds from the adsorbent using an organic solvent, the adsorbent may be washed with water.

An ordinary organic solvent may be used here, including alcohols, oils and fats.

The alcohol for use in the collecting step is, not specifically limited thereto, preferably ethanol or propylene glycol. Singly or as combined, a propylene glycol solution and an ethanol solution may be added to coffee-taste food and drink (for example, coffee drink), and apart from this, a mixture of the two may be prepared to be an aroma composition, and the resultant composition may be added to coffee-taste food and drink. In this description, the aroma composition obtained through desorption using propylene glycol is referred to as “PG solution”, and the aroma composition obtained through desorption using ethanol is referred to as “ethanol solution”.

The mixing ratio of the PG solution and the ethanol solution is any desired one, and for example, the mass ratio of the ethanol solution to the PG solution may be within a range of 0.1 to 10, 0.2 to 5, 0.5 to 3 or 0.8 to 2 relative to 1 part by mass of the PG solution. Also, for example, the mass ratio of the PG solution to the ethanol solution may be about 1/1, about 2/1, about 3/2, about 2/3, or about 1/2. The PG solution enhances the aroma at the top and enhances the voluminousness, mildness and the sustainability of the aroma in the middle and the later, and the ethanol solution enhances the voluminousness in the middle and later, and especially enhances the aroma at the top, and therefore, the ratio of the PG solution to the ethanol solution can be appropriately controlled in accordance with the desired taste and aroma, i.e., flavor.

Not adhering to any theory, propylene glycol and ethanol can acetalize a part of the collected aroma compound(s) (PG acetalization, diethyl acetalization) and, as a result, there is a probability that the flavor improving effect can be thereby increased.

Also in the present invention, the PG solution and the ethanol solution containing aroma compounds can be appropriately diluted with a solvent usable in food and drink, depending on the intended use purpose. Not specifically limited thereto, examples of the solvent include water (e.g., ion-exchanged water), alcohols such as ethanol, polysaccharides such as propylene glycol and glycerin, as well as triacetin, various fatty acids, and vegetable oils and fats. An aqueous alcohol solution of 50 to 100% by mass may be used. For ethanol, hydrous ethanol having an ethanol concentration of 50 to 95% by mass is preferably used; and for PG, 50 to 100 mass % PG is preferably used.

In the case where columns are used, the flow rate of alcohol to pass through the columns is preferably SV=0.1 to 20.

The amount of alcohol to be used is not specifically limited, and the flow amount thereof is preferably 1 to 100 times by volume of the adsorbent, more preferably 3 to 40 times, even more preferably 5 to 20 times thereof.

By eluting the aroma compounds adsorbed by the adsorbent with an alcohol, a water-soluble aroma composition (aroma condensate) can be obtained.

Not specifically limited, examples of the fats and oils for use for desorption include vegetable fats and oils such as soybean oil, rice oil, sesame oil, peanut oil, corn oil, rapeseed oil, coconut oil and palm oil, and hardened fats and oils thereof; animal fats and oils such as beef tallow, lard and fish oil, and hardened fats and oils thereof; and middle chain fatty acid triglycerides (hereinafter this may be referred to as MCT). From the viewpoint the stability of the aroma composition to be obtained, MCT is preferred. Examples of MCT include triglycerides of middle acid fatty acid having 6 to 12 carbon atoms, such as caproic acid triglyceride, caprylic acid triglyceride, capric acid triglyceride, lauric acid triglyceride and mixtures thereof. In particular, caprylic acid triglyceride, capric acid triglyceride and mixtures thereof are preferred. These MCT mixtures are inexpensive and are easily available on the market. A mixture of two or more aroma compositions each using different fats and oils may be used as an aroma composition obtained according to the production method of the present invention.

The amount of the fats and oils to be used herein differs depending on the type of the raw material and the aroma component concentration in the gas. Desorption may be carried out under a static condition, and the desorption temperature and the desorption time may be appropriately selected. For example, a desorption time falling within a range of 5 minutes to 2 hours at a temperature ranging from 10 to 80° C. may be referred to as one example of the operation. After desorption, the resultant desorbed liquid is kept statically, and may be subjected to separation between the oil part and the aqueous part according to an ordinary separation method of, for example, decantation or centrifugation. A component of fats and oils may be further added to the aqueous phase part for extraction to thereby efficiently collect the aroma components of interest. The resultant oil part may be dewatered, for example, using a dewatering agent such as anhydrous sodium sulfate, and may be filtered according to a clarification filtering means using, for example, filter paper to give an oil-soluble aroma composition.

### <Reuse and Washing of Adsorbent>

Regarding adsorbent, the pressure of the liquid flowing through the adsorbent before desorption with an organic solvent and that after desorption are compared, and when the two pressures are close to each other (for example, not more than 2 times), no clogging has occurred, or clogging is on an ignorable level, and it is judged that the adsorbent on that level is reusable without washing. The method of maintaining the aroma collecting apparatus may include a step of comparing the pressures of the liquid flowing through the adsorbent between before and after the desorption with an organic solvent, and confirming as to whether or not the pressures are close to each other. Specifically, it is preferable that, before and after desorption, the device is purged with pure water, then ultrapure water is introduced thereinto at SV=10 or so and the pressure of the water flow is measured, and then the pressure after desorption is calculated relative to the pressure before desorption.

On the other hand, the production method of the present invention may include an adsorbent washing step. Specifically, the method of maintaining the aroma collecting apparatus may include an adsorbent washing step. In the production method of the present invention, a fine powder and thin flakes are not almost adsorbed by the adsorbent, but any other component contained in the gas (especially a polymerizable component) may be adsorbed by the adsorbent. An adsorbent washing method is well known to those skilled in the art, in which several kinds of solvents each having a different polarity that varies sequentially are introduced into the adsorbent. The kind of the solvent is not specifically limited. For example, an alcohol substance such as PG or ethanol is introduced into the adsorbent for desorption, and then ethyl acetate and hexane are introduced thereinto in that order for washing the adsorbent, and in regenerating the adsorbent, ethyl acetate and water may be introduced thereinto in that order.

Preferably, the adsorbent is reused until the operation of desorption and collection are repeated for a total of 5 times or more while, if desired, it is washed after collection of aroma compounds therefrom. More preferably, the adsorbent is reused until the operation is repeated for a total of 10 times.

### <Confirmation Step>

Preferably, the production method of the present invention includes, in the case where the aroma composition is a solution containing aroma compounds that are emitted in grinding roasted coffee beans, a step of confirming as to whether or not the solution is a propylene glycol solution satisfying the following requirement A1, or an ethanol solution satisfying the requirement B1, or a combination thereof.

Requirement A1: In a total ion chromatogram obtained through electron-impact ionization (EI mode) at 70 eV using a gas chromatography mass spectrometer (GC/MS) equipped with a quadrupole mass analyzer and using polar columns, the chromatogram has peaks for 2-methylfuran, 2-methylbutyl aldehyde, isovaleraldehyde, 2,5-dimethylfuran, 3-hexanone, 2-vinylfuran, pyridine, 2,5-dimethylpyrazine, 2-ethyl-6-methylpyrazine and 3-ethylpyridine, the ratio of the total area of all the peaks having a retention index not more than that for acetoin to the total area (excepting for propylene glycol) of all the peaks in the chromatogram is 90% or more and less than 95%, and the ratio of the total area of all the peaks having a retention index larger than that for acetoin is to the total area (excepting for propylene glycol) of all the peaks in the chromatogram more than 5% and 10% or less.

Requirement B1: In a total ion chromatogram obtained through electron-impact ionization (EI mode) at 70 eV using a gas chromatography mass spectrometer (GCMS) equipped with a quadrupole mass analyzer and using polar columns, the chromatogram has peaks for 2-methylfuran, 2-methylbutyl aldehyde, isovaleraldehyde, 2,5-dimethylfuran, 3-hexanone, 2-vinylfuran, pyridine, 2,5-dimethylpyrazine, 2-ethyl-6-methylpyrazine and 3-ethylpyridine, the ratio of the total area of all the peaks having a retention index not more than that for acetoin to the total area (excepting for ethanol) of all the peaks in the chromatogram is 93% or more and less than 98%, and the ratio of the total area of all the peaks having a retention index larger than that for acetoin to the total area (excepting for ethanol) of all the peaks in the chromatogram is more than 2% and 7% or less.

Further, more preferably, the production method of the present invention includes a step of confirming as to whether or not the solution satisfies the following requirements.

Specifically, it is preferable that the solution is confirmed as to whether or not it satisfies the following requirement A2 and/or the following requirement B2 in the total ion chromatogram obtained through electron-impact ionization (EI mode) at 70 eV using a gas chromatography mass spectrometer (GC/MS) equipped with a quadrupole mass analyzer and using polar columns.

Requirement A2: In measurement under the following measurement condition, the peak areas for 2-methylfuran, 2-methylbutyl aldehyde, and isovaleraldehyde relative to the total area of the peaks in the chromatogram having an RI of not more than that for acetoin are 0.1 to 5.0%, 1.0 to 10%, and 1.0 to 10%, respectively, and the peak areas for 2,5-dimethylpyrazine and 2-ethyl-6-methylpyrazine relative to the total area of the peaks in the chromatogram having an RI of larger than that for acetoin are 0.1 to 2.5% and 0.5 to 3.0%, respectively.

Requirement B2: In measurement under the following measurement condition, the peak areas for 2-methylfuran, 2-methylbutyl aldehyde, and isovaleraldehyde relative to the total area of the peaks in the chromatogram having an RI of not more than that for acetoin are 0.05 to 5.0%, 1.0 to 10%, and 1.0 to 10%, respectively, and the peak areas for 2,5-dimethylpyrazine and 2-ethyl-6-methylpyrazine relative to the total area of the peaks in the chromatogram having an RI of larger than that for acetoin are 0.1 to 2.0% and 0.1 to 2.5%, respectively.

Measurement condition: Total ion chromatogram obtained through electron-impact ionization (EI mode) at 70 eV using a gas chromatography mass spectrometer (GC/MS) equipped with a quadrupole mass analyzer and using polar columns.

The type of the polar columns is not specifically limited, and any available polar columns are usable here. Examples thereof include polar column of InertCap-WAX Series (manufactured by GL Science Inc.) such as InertCap-WAX columns, though not specifically limited thereto.

### [Aroma Composition]

The aroma composition (preferably, a coffee flavor improver) produced according to the production method of the present invention contains aroma compounds that are emitted in grinding roasted coffee beans, and gives an aroma that is emitted in grinding roasted coffee beans. When the aroma composition is added to a food or drink having a coffee-like flavor (for example, coffee drink), as a coffee flavor improver, it preferably enhances a sweet and roasty aroma that is given at the top, and also enhances or improves the flavor given in the middle and later (for example, mellows the flavor or enhances a voluminous feel), and also preferably enhances the flavor sustainability.

Specifically, the aroma that is emitted in grinding roasted coffee beans is preferably an aroma perceivable in grinding roasted coffee beans, and is also preferably an intense aroma given at the top, and the aroma is preferably a voluminous even in the middle and later and has a good aftertaste.

Some preferred embodiments of the present invention are shown in Examples to be given hereinunder, and the present invention is based on an extremely surprising finding that, for collecting aroma compounds that are emitted in grinding roasted coffee beans, in particular, use of propylene glycol and/or ethanol among various solvents heretofore used in the food field provides a remarkable and multiple flavor enhancing effect. The coffee flavor improver obtained in the present invention exhibits an excellent flavor improving effect not only for the aroma at the top but also for the aroma in the middle and later, and can therefore improve the flavor of coffee drink in a well-balanced manner heretofore not experienced in the art. Not adhering to any theory, the reason could be presumed to be as follows.

First, the coffee flavor improver obtained in the present invention contains an aroma compound(s) highly volatile and given at the top in a high ratio, and contains adequately an aroma compound(s) relatively heavy and given in the middle and later, and therefore, it is considered that when the improver is added to a coffee-taste food and drink, it can sufficiently increase a light aroma compound(s) (that is, the aroma at the top) that may be often lost in producing the food and drink and also can enhance the flavor thereof in the middle and later, and consequently, the improver can enhance the flavor of the coffee-taste food and drink, as a whole, in a well-balanced manner heretofore not experienced in the art. Further, it is considered that, in desorbing the aroma compounds from the adsorbent, minor amounts of reaction products between the aroma component and the desorbent liquid (for example, a PG acetal compound(s) (a propylene glycol acetal compound(s)), a diethyl acetal compound(s), an ethyl ester compound(s), etc.) may form, and these may have some influence on the flavor at the top or in the middle and later.

It is presumed that, owing to the interactions of the above-mentioned points, the present invention can exhibit the following excellent effects for coffee-taste food and drink.
It enhances the sweet and roasty aroma that is given at the top, and also enhances the flavor in the middle and later to give mildness thereto, and increases the flavor sustainability.
It sharpens the aftertaste of food and drink.
It enhances light and fresh milk-like flavor.

In the case where the aroma composition is a PG solution, in a total ion chromatogram obtained through electron-impact ionization (EI mode) at 70 eV using a gas chromatography mass spectrometer (GC/MS) equipped with a quadrupole mass analyzer and using polar columns, the ratio of the total area of all the peaks having a retention index not more than that for acetoin to the total area of all the peaks having a retention index larger than that for acetoin may include any two ratios selected from 80:20, 85:15, 87:13, 90:10, 92:8, 94:6, 95:5, 97:3 and 98:2 as the upper limit and the lower limit, and more preferably, may fall within any range of 85:15 to 95:5, 85:15 to 97:3, 87:13 to 95:5, 87:13 to 97:3, 90:10 to 95:5, 90:10 to 97:3 or 92:8 to 97:3. In the case where the aroma composition is an ethanol solution, the ratio may include any two ratios selected from 90:10, 92:8, 95:5, 94:6, 97:3 and 98:2 as the upper limit and the lower limit, and more preferably may fall within any range of 90:10 to 95:5, 90:10 to 98:2, 92:8 to 95:5 or 92:8 to 97:3. Preferably, the total area of all the peaks having a retention index not more than that for acetoin is larger than the total area of all the peaks having a retention index larger than that for acetoin, and may be more than 1 time, 2 times or more, 3 times or mire, 4 times or more, 5 times or more, 7 times or more, 8 times or more, 10 times or more, 12 times or more, 15 times or more, 20 times or more, 25 times or more, 30 times or more, 35 times or more, 40 times or more, 45 times or more, or 50 times or more.

In this description, in calculation of the peak area in the total ion chromatogram of the aroma composition, the peak(s) for the solvent in the aroma composition (that is, the solvent used in the collecting step) are excluded. In other words, in the case where the solvent used in the collecting step is propylene glycol, the peak(s) for propylene glycol are excluded in calculating the peak area in the total ion chromatogram. The same shall apply to the case where the solvent used in the collecting step is ethanol.

Preferably, the aroma composition obtained according to the production method of the present invention contains one or more aroma compounds selected from the following group A, and preferably, by adding the aroma composition to a coffee drink as a coffee flavor improver, the content of one or more compounds selected from the following group A can be increased in the resultant drink.

(Group A) Acetaldehyde, acetone, 2-methylbutyl aldehyde, isobutyl aldehyde, isovaleraldehyde, 2-methylfuran, methyl ethyl ketone, diacetyl, 2,3-pentanedione, 2,3-hexanedione, N-methylpyrrole, 2-methyl-5-vinylfuran, pyridine, pyrazine, furfuryl methyl ether, acetoin, 3-methylpyridine, acetol, 3-hydroxy-2-pentanone, 2,3-dimethylpyrazine, 2-methyl-2-cyclopentenone, 1-hydroxy-2-butanone, furan, 2,5-dimethylfuran, 3-hexanone, 2-vinylfuran, pyridine, 3-ethylpyridine, 2-vinylfuran, ethyl acetate, 2,5-diethylpyrazine, 2,6-dimethylpyrazine, 2-ethylpyrazine, 2-ethyl-6-methylpyrazine, 2-ethyl-5-methylpyrazine, 2-ethyl-3-methylpyrazine, 2-acetylfuran, 2-furfurylmethyl disulfide, 2,3,5-trimethylpyrazine, acetic acid, acetol acetate, 2-vinylpyrazine, furfural, furfuryl formate, 2,5-dimethyl-3(2H)-furanone, 2-acetylfuran, pyrrole, furylacetone, acetol propionate, furfuryl acetate, 5-methyl-2-furfural, furfuryl propionate, γ-butyrolactone, furfuryl alcohol, 1-(1-pyrrolyl)-2-propanone, 2,5-dimethylpyrazine, 3-ethylpyrazine, 2,6-diethylpyrazine, 3-ethyl-2,5-dimethylpyrazine, I-furfurylpyrrole, phenol.

In particular, it is desirable that the aroma composition obtained according to the production method of the present invention contains one or more aroma compounds selected from the following group B, and that, by adding the aroma composition to a coffee drink as a coffee flavor improver, the content of one or more compounds selected from the following group B can be increased in the resultant drink.

(Group B) 2-Methylbutyl aldehyde, isovaleraldehyde, 2-methylfuran, furan, 2,5-dimethylfuran, 3-hexanone, 2-vinylfuran, pyridine, 3-ethylpyridine, 2-vinylfuran, ethyl acetate.

In the case where the aroma composition is a propylene glycol solution, preferably, the propylene glycol solution further contains one or more selected from the group consisting of 2-methylbutyl aldehyde propylene glycol acetal, 2-methylbutanal propylene glycol acetal, 2-methylfuran propylene glycol acetal, and isovaleraldehyde propylene glycol acetal. More preferably, the propylene glycol solution contains one or more PG acetals selected from 2-methylbutanal PG acetal, 2-methylfuran PG acetal, isovaleraldehyde PG acetal, and 2-methylbutyl aldehyde PG acetal, even more preferably contains at least isovaleraldehyde PG acetal, and especially more preferably contains at least 2-methylbutyl aldehyde PG acetal and isovaleraldehyde PG acetal. Not adhering to any theory, it is considered that these acetals can enhance the flavor improving effect (especially the flavor improving effect in the middle and later).

In the case where the aroma composition is a propylene glycol solution, preferably the composition contains dipropylene glycol.

On the other hand, in the case where the aroma composition is an ethanol solution, the composition preferably contains diethyl acetal.

In the above-mentioned total ion chromatogram, examples of the compounds belonging to all the peaks having a retention index not more than that for acetoin are shown below along with acetoin.

Acetaldehyde, isobutyl aldehyde, acetoin, methyl ethyl ketone, ethanol, diacetyl, 2,3-pentanedione, 2,3-hexanedione, N-methylpyrrole, 2-methyl-5-vinylfuran, pyrazine, furfuryl methyl ether, furan, ethyl acetate, 2,5-dimethylfuran, 3-hexanone, 2-vinylfuran, pyridine, 2-methylfuran, 2-methylbutanal PG acetal, 2-methylbutyl aldehyde, isovaleraldehyde, 2-methylbutyl aldehyde PG acetal, isovaleraldehyde PG acetal, acetone (RI=1294).

In the above-mentioned total ion chromatogram, examples of the compounds belonging to all the peaks having a retention index larger than that for acetoin are shown below.

Acetol (RI=1321), furfural, 2-acetylfuran, furfuryl acetate, 3-methylpyridine, 2,5-dimethylpyrazine, 2,6-dimethylpyrazine, 2-ethylpyrazine, 3-hydroxy-2-pentanone, 2,3-dimethylpyrazine, 2-methyl-2-cyclopentenone, 1-hydroxy-2-butanone, 3-ethylpyridine, 2-ethyl-6-methylpyrazine, 2-ethyl-5-methylpyrazine, 2,3,5-trimethylpyrazine, 2-vinylpyrazine, acetic acid, acetol acetate, furfuryl formate, 2,5-dimethyl-3(2H)-furanone, pyrrole, furyl acetate, acetol propionate, 5-methyl-2-furfural, furfuryl propionate, γ-butyrolactone, furfuryl alcohol, 1-(1-pyrrolyl)-2-propanone, dipropylene glycol, phenol.

In the case where the aroma composition obtained according to the production method of the present invention is a propylene glycol solution, the proportions of the peak areas for 2-methylfuran; 2-methylbutyl aldehyde; and isovaleraldehyde to the total area of all the peaks having a retention index not more than that for acetoin in the above-mentioned total ion chromatogram may be 0.1 to 5.0%, 1.0 to 10% and 1.0 to 10%; 0.5 to 4.0%, 2.0 to 8.0% and 2.0 to 8.0%; 1.0 to 3.0%, 3.0 to 7.0% and 3.0 to 7.0%; or 1.5 to 2.5%, 4.0 to 6.0% and 3.0 to 6.0%, respectively. In the case where the aroma composition is an ethanol solution, the proportions may be 0.05 to 5.0%, 1.0 to 10% and 1.0 to 10%; 0.2 to 4.0%, 1.2 to 8.0% and 1.1 to 8.0%; 0.5 to 3.0%, 1.4 to 7.0% and 1.2 to 7.0%; or 1.0 to 2.0%, 1.6 to 6.0% and 1.2 to 6.0%, respectively.

In the case where the aroma composition obtained according to the production method of the present invention is a propylene glycol solution, the proportions (%) of peak areas for 2,5-dimethylfuran, 2-vinylfuran, pyridine and acetoin to the total area of all the peaks having a retention index not more than that for acetoin in the above-mentioned total ion chromatogram may be as follows:

2,5-Dimethylfuran: 0.1 to 2.0, 0.2 to 1.5, or 0.5 to 1.3;

2-Vinylfuran: 0.1 to 2.0, 0.2 to 1.5, or 0.5 to 1.3;

Pyridine: 0.5 to 3.0, 1.0 to 2.5, or 1.3 to 2.3;

Acetoin: 0.5 to 3.0, 1.0 to 2.5, or 1.3 to 2.3.

In the case where the aroma composition is an ethanol solution, the proportions (%) of peak areas value for 2,5-dimethylfuran, 2-vinylfuran, pyridine and acetoin to the total area of all the peaks having a retention index not more than that for acetoin in the above-mentioned total ion chromatogram may be as follows:

2,5-Dimethylfuran: 0.5 to 3.5, 1.0 to 3.0, or 1.5 to 2.5;

2-Vinylfuran: 0.1 to 2.0, 0.2 to 1.5, or 0.5 to 1.3;

Pyridine: 0.1 to 2.5, 0.5 to 2.0, or 0.7 to 1.7;

Acetoin: 0.5 to 3.0, 1.0 to 2.5, or 1.3 to 2.3.

In the case where the aroma composition is a propylene glycol solution, the proportions (%) of peak areas for 2,5-dimethylpyrazine, 2-ethyl-6-methylpyrazine, 2,6-dimethylpyrazine, 2-ethylpyrazine, 3-ethyl-2,5-dimethylpyrazine, 2-acetylfuran and 1-furfurylpyrrole to the total area of all the peaks having a retention index larger than that for acetoin in the above-mentioned total ion chromatogram may be as follows:

2,5-Dimethylpyrazine: 0.1 to 2.5, 0.5 to 2.0, 1.2 to 1.9;

2-Ethyl-6-methylpyrazine: 0.5 to 3.0, 1.0 to 2.7, 1.7 to 2.3;

2,6-Dimethylpyrazine: 0.1 to 2.5, 0.5 to 2.0, or 0.7 to 1.7;

2-Ethylpyrazine: 0.1 to 2.0, 0.2 to 1.5, or 0.7 to 1.3;

3-Ethyl-2,5-dimethylpyrazine: 0.1 to 2.0, 0.2 to 1.5, or 0.3 to 0.9;

2-Acetylfuran: 0.1 to 2.5, 0.5 to 2.0, or 0.7 to 1.7;

1-Furfurylpyrrole: 0.1 to 2.0, 0.2 to 1.5, or 0.3 to 0.9.

In the case where the aroma composition is an ethanol solution, the proportions (%) of peak areas for 2,6-dimethylpyrazine, 2-ethylpyrazine, 3-ethyl-2,5-dimethylpyrazine, 2-acetylfuran, and 1-furfurylpyrrole to the total area of all the peaks having a retention index larger than that for acetoin in the above-mentioned total ion chromatogram may be as follows:

2,5-Dimethylpyrazine: 0.1 to 2.0, 0.3 to 1.5, 0.4 to 1.0;

2-Ethyl-6-methylpyrazine: 0.1 to 2.5, 0.3 to 2.0, 0.7 to 1.4;

2,6-Dimethylpyrazine: 0.1 to 2.0, 0.2 to 1.5, or 0.3 to 0.9;

2-Ethylpyrazine: 0.1 to 2.0, 0.2 to 1.5, or 0.3 to 0.9;

3-Ethyl-2,5-dimethylpyrazine: 0.1 to 2.0, 0.2 to 1.5, or 0.3 to 0.9;

2-Acetylfuran: 0.1 to 2.0, 0.2 to 1.5, or 0.3 to 0.9;

1-Furfurylpyrrole: 0.1 to 2.0, 0.2 to 1.5, or 0.7 to 1.3.

### [Use of Aroma Composition Produced According to Production Method of the Invention]

The aroma composition produced according to the method for producing an aroma composition of the present invention can be added to various substrates such as foods and drinks, cosmetics, health and hygiene products and medicines. The aroma composition produced according to the method for producing an aroma composition of the present invention is preferably used for substrates that give a coffee-like flavor, and more preferably the composition is added to foods and drinks that give coffee-like flavor. Further, the aroma composition obtained according to the production method of the present invention can be used as a coffee flavor improver and added to various flavoring compositions that are required to be given a coffee flavor. In the present invention, coffee flavor or taste means an aroma and/or a flavor that may evoke coffee or roasted coffee beans.

Preferably, food and drink may contain, as added thereto, the aroma composition produced by the method for producing an aroma composition of the present invention in an amount of 0.01 to 10% by mass relative to the total mass of the food and drink, more preferably 0.05 to 7% by mass. Preferably, the aroma composition containing, as added thereto, a coffee flavor improver contains the coffee flavor improver in an amount of 0.1 to 10% by mass relative to the total mass of the aroma composition to which the coffee flavor improver is added, more preferably 0.5 to 5% by mass.

The food and drink is preferably a packed food or drink, more preferably a packed drink. The aroma composition produced according to the method for producing an aroma composition of the present invention contains a relatively large amount of an aroma compound(s) given at the top (a highly volatile component(s) having a low molecular weight). Consequently, the packed drink that contains the aroma composition produced according to the production method of the present invention can give, when unpacked, a rich aroma that is emitted in grinding roasted coffee beans. In addition, it can give an aroma (a component(s) relatively poorly volatile) in the middle and later. Consequently, the aroma composition can impart a fresh aroma of just ground roasted coffee beans to coffee-taste food and drink, and can enhance such a fresh aroma thereof, and in addition, can totally enhance and improve the coffee flavor of food and drink.

Examples of the packed food and drink include frozen desserts such as ice cream, soft cream and sherbet; confectionery such as biscuit, cookie, rice cracker, steamed yeast bun with filling, chocolate, cream-filled confectionery, jelly, gum and candy; coffee-taste drink such as black coffee, coffee with milk, café latte, café-au-lait, milk coffee, coffee-taste soy milk drink, coffee-taste energy drink, coffee-taste carbonated drink, coffee-taste and alcoholic drink; bread, spread for bread, coffee-taste health foods (for example, Foods with Function Claims, dietary supplement, food for specified health use) and other foods indicated to have coffee flavor. More specifically, they include sugarless black coffee, sugared black coffee, milk coffee (including café latte type and café-au-lait type), coffee jelly, coffee candy, and coffee liqueur, though not limited thereto.

Packed drink means a drink having a suitable concentration for drinking and is packed in a container (generally, it is sterilized before and after packed in a container).

The packed drink is preferably a packed drink filled in a PET bottle, a can or a paper container. The packed drink includes tea-type drink such as barley tea drink, cereal tea drink, brown rice tea drink, and so-called mixed tea drink prepared by mixing tea and roasted cereal (blend tea drink); tea-type drink such as green tea drink, oolong tea drink, and red tea drink; coffee drink; and beer-taste drink such as beer, low-malt beer, so-called third beer (quasi-beer), nonalcoholic beer-taste drink. Among these, coffee is preferred.

The type of the coffee for use as the substrate is not specifically limited. For example, coffee described in [0028] to [0039] in JP 2013-252112 Å, and in [0037] to [0042] in JP 2015-149950 Å may be employed here, and the contents in these patent publications are incorporated herein by reference.

Preferred embodiments of flavored products (food and drink) before thermal sterilization, using coffee as a substrate, are described below.

In a total ion chromatogram of food and drink before thermal sterilization, as obtained through electron-impact ionization (EI mode) at 70 eV using a gas chromatography mass spectrometer (GC/MS) equipped with a quadrupole mass analyzer and using polar columns, when the total area of all the peaks having a retention index not more than that for acetoin for the substrate (sugarless black coffee) before thermal sterilization is referred to as 100%, the total area of all the peaks having a retention index not more than that for acetoin for the food and drink (flavored product) before thermal sterilization is preferably more than 100%, more preferably 102% or more, even more preferably 103% or more, further more preferably 105% or more, still further more preferably 107% or more, still further more preferably 110% or more, and especially still further more preferably 111%% or more.

In the above-mentioned total ion chromatogram where the peak area for 2-methylfuran in the substrate (sugarless black coffee) before thermal sterilization is referred to as 100%, preferably, the peak area for 2-methylfuran in the food and drink (flavored product) before thermal sterilization is more than 100%, more preferably 105% or more, even more preferably 110% or more, still more preferably 115% or more, and further more preferably 120% or more.

In the above-mentioned total ion chromatogram where the peak area for 2-methylbutyl aldehyde in the substrate (sugarless black coffee) before thermal sterilization is referred to as 100%, preferably, the peak area for 2-methylbutyl aldehyde in the food and drink (flavored product) before thermal sterilization is more than 100%, more preferably 105% or more, even more preferably 110% or more, still more preferably 115% or more.

In the above-mentioned total ion chromatogram where the peak area for isovaleraldehyde in the substrate (sugarless black coffee) before thermal sterilization is referred to as 100%, preferably, the peak area for isovaleraldehyde in the food and drink (flavored product) before thermal sterilization is more than 100%, more preferably 105% or more, even more preferably 110% or more, still more preferably 115% or more, further more preferably 120% or more, and even further more preferably 125% or more.

In the above-mentioned total ion chromatogram where the peak area for furan in the substrate (sugarless black coffee) before thermal sterilization is referred to as 100%, preferably, the peak area for furan in the food and drink (flavored product) before thermal sterilization is more than 100%, more preferably 105% or more, even more preferably 110% or more, still more preferably 115% or more, further more preferably 120% or more, even further more preferably 125% or more, and still further more preferably 130% or more.

In the above-mentioned total ion chromatogram where the peak area for 2,5-dimethylfuran in the substrate (sugarless black coffee) before thermal sterilization is referred to as 100%, preferably, the peak area for 2,5-dimethylfuran in the food and drink (flavored product) before thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

In the above-mentioned total ion chromatogram where the peak area for 3-hexanone in the substrate (sugarless black coffee) before thermal sterilization is referred to as 100%, preferably, the peak area for 3-hexanone in the food and drink (flavored product) before thermal sterilization is more than 100%, more preferably 105% or more, even more preferably 110% or more, still more preferably 115% or more, further more preferably 120% or more, even further more preferably 125% or more, and still further more preferably 130% or more.

In the above-mentioned total ion chromatogram where the peak area for 2-vinylfuran in the substrate (sugarless black coffee) before thermal sterilization is referred to as 100%, preferably, the peak area for 2-vinylfuran in the food and drink (flavored product) before thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

In the above-mentioned total ion chromatogram where the peak area for pyridine in the substrate (sugarless black coffee) before thermal sterilization is referred to as 100%, preferably, the peak area for pyridine in the food and drink (flavored product) before thermal sterilization is more than 100%, more preferably 105% or more, even more preferably 110% or more, still more preferably 115% or more, further more preferably 120% or more, even further more preferably 125% or more, and still further more preferably 130% or more.

In the above-mentioned total ion chromatogram where the peak area for 3-ethylpyridine in the substrate (sugarless black coffee) before thermal sterilization is referred to as 100%, preferably, the peak area for 3-ethylpyridine in the food and drink (flavored product) before thermal sterilization is more than 100%, more preferably 105% or more, even more preferably 110% or more, still more preferably 115% or more.

In the above-mentioned total ion chromatogram where the peak area for 2,5-dimethylpyrazine in the substrate (sugarless black coffee) before thermal sterilization is referred to as 100%, preferably, the peak area for 2,5-dimethylpyrazine in the food and drink (flavored product) before thermal sterilization is more than 100%, more preferably 105% or more, even more preferably 110% or more, still more preferably 113% or more.

In the above-mentioned total ion chromatogram where the peak area for 2-ethyl-6-methylpyrazine in the substrate (sugarless black coffee) before thermal sterilization is referred to as 100%, preferably, the peak area for 2-ethyl-6-methylpyrazine in the food and drink (flavored product) before thermal sterilization is more than 100%, more preferably 105% or more, even more preferably 110% or more, still more preferably 115% or more.

In the above-mentioned total ion chromatogram where the peak area for ethyl acetate in the substrate (sugarless black coffee) before thermal sterilization is referred to as 100%, preferably, the peak area for ethyl acetate in the food and drink (flavored product) before thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

The food and drink may be thermally sterilized. In production of packed drinks, the products are subjected to retort sterilization (thermal sterilization at 121° C. for 10 minutes or so) or UHT sterilization (thermal sterilization at 135° C. for 1 minute or so). However, ordinary aroma at the top is often lost by heating. The aroma composition produced according to the method for producing an aroma composition of the present invention has a strong aroma at the top and hardly loses the top aroma even when heated, and is therefore favorably used for food and drink to be thermally sterilized. In addition, consequently, the aroma composition of the present invention is also favorably used even in food and drink that are required to be heated before eating.

Preferred embodiments of food and drink after thermal sterilization, using coffee as a substrate, are described.

In a total ion chromatogram of food and drink after thermal sterilization, as obtained through electron-impact ionization (EI mode) at 70 eV using a gas chromatography mass spectrometer (GC/MS) equipped with a quadrupole mass analyzer and using polar columns, when the total area of all the peaks having a retention index not more than that for acetoin for the substrate (sugarless black coffee) after thermal sterilization is referred to as 100%, the total area of all the peaks having retention index not more than that for acetoin for the food and drink (flavored product) after thermal sterilization is preferably more than 100%, more preferably 102% or more, even more preferably 103% or more, further more preferably 105% or more, still further more preferably 107% or more.

In the above-mentioned total ion chromatogram where the peak area for 2-methylfuran in the substrate (sugarless black coffee) after thermal sterilization is referred to as 100%, preferably, the peak area for 2-methylfuran in the food and drink (flavored product) after thermal sterilization is more than 100%, more preferably 105% or more, even more preferably 110% or more, still more preferably 115% or more.

In the above-mentioned total ion chromatogram where the peak area for 2-methylbutyl aldehyde in the substrate (sugarless black coffee) after thermal sterilization is referred to as 100%, preferably, the peak area for 2-methylbutyl aldehyde in the food and drink (flavored product) after thermal sterilization is more than 100%, more preferably 105% or more, even more preferably 110% or more, still more preferably 115% or more.

In the above-mentioned total ion chromatogram where the peak area for isovaleraldehyde in the substrate (sugarless black coffee) after thermal sterilization is referred to as 100%, preferably, the peak area for isovaleraldehyde in the food and drink (flavored product) after thermal sterilization is more than 100%, more preferably 105% or more, even more preferably 110% or more, still more preferably 115% or more.

In the above-mentioned total ion chromatogram where the peak area for 2,5-dimethylfuran in the substrate (sugarless black coffee) before thermal sterilization is referred to as 100%, preferably, the peak area for 2,5-dimethylfuran in the food and drink (flavored product) after thermal sterilization is more than 100%, more preferably 105% or more, even more preferably 110% or more, still more preferably 115% or more, further more preferably 120% or more, even further more preferably 125% or more, still further more preferably 130% or more, and still further more preferably 140% or more.

In the above-mentioned total ion chromatogram where the peak area for 3-hexanone in the substrate (sugarless black coffee) after thermal sterilization is referred to as 100%, preferably, the peak area for 3-hexanone in the food and drink (flavored product) after thermal sterilization is more than 100%, more preferably 105% or more, even more preferably 110% or more, still more preferably 115% or more, further more preferably 120% or more, even further more preferably 125% or more, and still further more preferably 130% or more.

In the above-mentioned total ion chromatogram where the peak area for 2-vinylfuran in the substrate (sugarless black coffee) after thermal sterilization is referred to as 100%, preferably, the peak area for 2-vinylfuran in the food and drink (flavored product) after thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

In the above-mentioned total ion chromatogram where the peak area for pyridine in the substrate (sugarless black coffee) after thermal sterilization is referred to as 100%, preferably, the peak area for pyridine in the food and drink (flavored product) after thermal sterilization is more than 100%, more preferably 105% or more, even more preferably 110% or more, still more preferably 115% or more, further more preferably 120% or more.

In the above-mentioned total ion chromatogram where the peak area for 3-ethylpyridine in the substrate (sugarless black coffee) after thermal sterilization is referred to as 100%, preferably, the peak area for 3-ethylpyridine in the food and drink (flavored product) after thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

In the above-mentioned total ion chromatogram where the peak area for 2,5-dimethylpyrazine in the substrate (sugarless black coffee) after thermal sterilization is referred to as 100%, preferably, the peak area for 2,5-dimethylpyrazine in the food and drink (flavored product) after thermal sterilization is more than 100%, more preferably 105% or more, even more preferably 110% or more, still more preferably 112% or more.

In the above-mentioned total ion chromatogram where the peak area for 2-ethyl-6-methylpyrazine in the substrate (sugarless black coffee) after thermal sterilization is referred to as 100%, preferably, the peak area for 2-ethyl-6-methylpyrazine in the food and drink (flavored product) after thermal sterilization is more than 100%, more preferably 105% or more, even more preferably 110% or more, still more preferably 115% or more.

In the above-mentioned total ion chromatogram where the peak area for ethyl acetate in the substrate (sugarless black coffee) after thermal sterilization is referred to as 100%, preferably, the peak area for ethyl acetate in the food and drink (flavored product) after thermal sterilization is more than 100%, more preferably 105% or more, even more preferably 110% or more, still more preferably 115% or more, further more preferably 120% or more, even further more preferably 125% or more, still further more preferably 130% or more, and especially more preferably 140% or more.

[Apparatus for Collecting Aroma from Roasted Coffee Beans]

The apparatus for collecting aroma from roasted coffee beans of the present invention (hereinafter this may be referred to as the aroma collecting apparatus of the present invention) includes a device for grinding roasted coffee beans,

a first flow channel which is communicated with the grinding device and through which a gas can flow, the gas containing aroma compounds that are emitted from roasted coffee beans in grinding the roasted coffee beans and a fine powder and thin flakes,

a fine powder and thin flakes removing device communicated with the first flow channel,

a second flow channel which is communicated with the fine powder and thin flakes removing device and through which the gas, from which a fine powder and thin flakes have been removed, can flow,

an aroma compound adsorbing device communicated with the second flow channel, and

a gas flow generating device that generates a gas flow continuing from the grinding device to the aroma compound adsorbing device, and in which:

the aroma compound adsorbing device has an adsorbent holder that holds an adsorbent therein, and the adsorbent holder has a mesh lid at both ends thereof in the gas flowing direction therethrough.

Preferred embodiments of the aroma collecting apparatus of the present invention are described below.

### <Overall Structure of Aroma Collecting Apparatus>

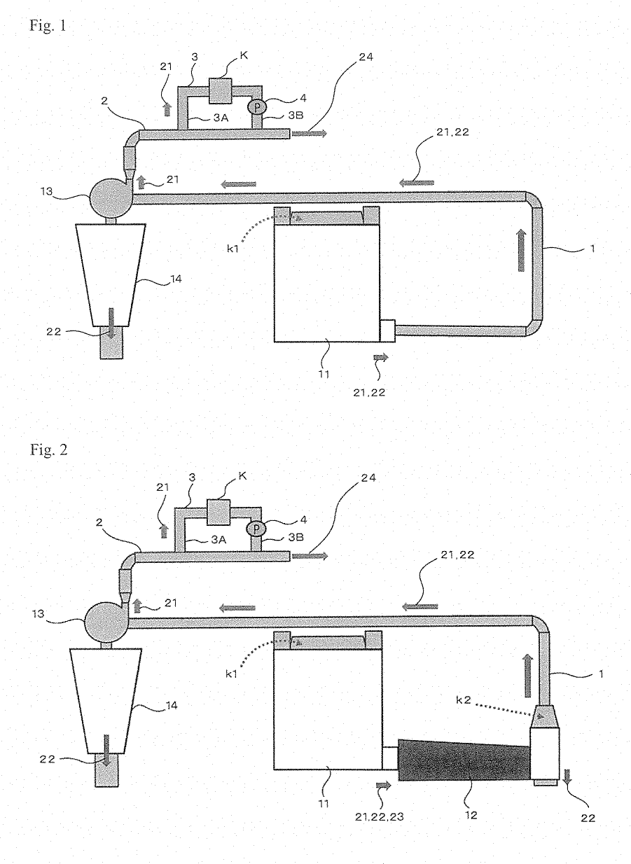

The overall structure of the aroma collecting apparatus is described with reference to the drawings attached hereto. FIG. 1 is a schematic view showing an example of an aroma collecting apparatus of the present invention. FIG. 2 is a schematic view showing another example of an aroma collecting apparatus of the present invention.

One example of the aroma collecting apparatus of FIG. 1 is provided with a grinding device 11, a first flow channel 1, a gas flow generating device 13, a fine powder and thin flakes removing device 14, a second flow channel 2, and an aroma compound adsorbing device K. The aroma compound adsorbing device K has an adsorbent holder Kb having mesh lids Ka1 and Ka2 (FIG. 3). Further, one example of the aroma collecting apparatus of FIG. 1 is provided with a guide path 3 and a linear speed controlling device 4, but these are not indispensable components.

In the aroma collecting apparatus of FIG. 1, a grinding system having the grinding device 11, the first flow channel 1, the gas flow generating device 13, the fine powder and thin flakes removing device 14 and the second flow channel 2 is generally used (for example, see U.S. Pat. No. 1,649,781 (1927)), and in the present invention, the aroma compound adsorbing device K is provided in such an ordinary grinding system so as to collect aroma compounds emitted from roasted coffee beans in grinding roasted coffee beans.

In the aroma collecting apparatus of FIG. 1, while roasted coffee beans are ground in the grinding device 11 to give a crude ground powder of roasted coffee beans, a gas that contains aroma compounds 21 emitted from the roasted coffee beans and a fine powder and thin flakes 22 contained in the crude ground powder of roasted coffee beans is moved toward the first flow channel 1 from the grinding device 11 by the gas flow generated in the gas flow generating device 13. The gas that contains the aroma compounds and the fine powder and thin flakes 22 moves with the gas flow from the first flow channel 1 to the fine powder and thin flakes removing device 14. In the fine powder and thin flakes removing device 14, the gas from which a fine powder and thin flakes have been removed (but which contains the aroma compounds 21) moves toward the second flow channel 2 while the fine powder and the thin flakes 22 are, after removed in the fine powder and thin flakes removing device 14, discharged out of the apparatus. With the gas flow generated in the gas flow generating device 13 (optionally along with the gas flow generated in the linear speed controlling device 4), a part of the gas from which a fine powder and thin flakes have been removed (containing the aroma compounds 21) flows from the second flow channel 2 into the guide path 3, and then flows into the adsorbent held in the aroma compound adsorbing device K arranged in the guide path 3, that is, the gas is introduced into the adsorbent so that the aroma compounds 21 are adsorbed by the adsorbent. The gas from which the aroma compounds 21 has been adsorbed by the adsorbent and which has flowed through the adsorbent is again moved to the second flow channel 2 through the outlet port 3B of the guide path, and is combined with the gas which did not flow into the guide path 3 but flowed through the second flow channel 2 and from which a fine powder and thin flakes were removed, and is discharged out of the apparatus as an exhaust gas 24.

In the present invention the guide path 3 is not an indispensable component as so mentioned hereinabove, and therefore, without providing the guide path 3, not a part but all of the gas flowing through the second flow channel (containing the aroma compounds 21 but not containing the fine powder and thin flakes) may be introduced into the aroma compound adsorbing device K. In this case, the aroma compound adsorbing device K may be arranged in the second flow channel.

Another example of the aroma collecting apparatus of FIG. 2 is provided with a grinding device 11, a fine power and thin flakes preremoving device 12, a first flow channel 1, a gas flow generating device 13, a fine powder and thin flakes removing device 14, a second flow channel 2, and an aroma compound adsorbing device K. The example of the aroma collecting apparatus of FIG. 2 is provided with a guide path 3 and a linear speed controlling device 4, but these are not indispensable components.

In the aroma collecting apparatus of FIG. 2, a crude ground powder of roasted coffee beans produced by grinding roasted coffee beans in the grinding device 11 is transferred to the fine powder and thin flakes preremoving device 12 by a transport system not shown. In the fine powder and thin flakes preremoving device 12, at least a part of the fine powder and thin flakes 22 are removed from the crude ground powder of roasted coffee beans, and the removed fine powder and thin flakes 22 are housed in a waste chamber not shown and are thus discharged out of the system. On the other hand, the gas containing the aroma compounds 21 and containing the fine powder and thin flakes 22 not removed in the fine powder and thin flakes preremoving device 12 moves toward the first flow channel 1 along with the gas flow generated in the gas flow generating device 13. The flow of the aroma compounds 21 and the fine powder and thin flakes 22 after the first flow channel 1 is the same as in FIG. 1.

Preferred embodiments of the devices which the aroma collecting apparatus preferably includes are described hereinunder.

### <Grinding Device>

The aroma collecting apparatus of the present invention is provided with a grinding device for roasted coffee beans.

The grinding device is not specifically limited. For example, a roller mill may be used.

The gas to be generated by grinding in the grinding device 11 is transported to the adsorbent along with the gas flow generated in the gas flow generating device and is therefore hardly spread out, and consequently, the grinding device is not necessarily required to be closed up. However, from the viewpoint of efficiently collecting the aroma compounds, the grinding device 11 may be communicated with the first flow channel 1 and the other parts may be closed up during grinding operation.

### <Fine Powder and Thin Flakes Preremoving Device>

Preferably, the aroma collecting apparatus of the present invention is further provided with a fine powder and thin flakes preremoving device between the grinding device and the first flow channel.

Preferably, the fine powder and thin flakes preremoving device is communicated with the grinding device to remove at least a part of the fine powder and thin flakes from the crude ground powder of roasted coffee beans obtained by grinding roasted coffee beans. The pure ground powder of roasted coffee beans from which a fine powder and thin flakes have been removed (that is, a ground powder of roasted coffee beans themselves ground to have a desired size) can be used as a food or drink or for production thereof.

A part of most of the fine powder and thin flakes may be removed and discharged out of the system. When the amount of the fine powder and thin flakes that move to the first flow channel from the fine powder and thin flakes preremoving device is smaller, the load on the downstream, i.e., the fine powder and thin flakes removing device, can be reduced more.

Any known device is usable as the fine powder and thin flakes preremoving device, and a classification device such as a shaking sieve or a wind-driven classifier is preferably used.

### <First Flow Channel>

The aroma collecting apparatus of the present invention is provided with a first flow channel which is communicated with the grinding device and through which the gas can flow, wherein the gas contains the aroma compounds that are emitted from the roasted coffee beans in grinding roasted coffee beans and the fine powder and thin flakes.

The first flow channel may be directly communicated with the grinding device, or may be communicated with the grinding device via the fine powder and thin flakes preremoving device.

Though not specifically limited, the diameter (inner diameter) of the first flow channel is, from the viewpoint of making more gas flow therethrough, preferably 30 mm or more, more preferably 50 mm or more, even more preferably 100 mm or more, further more preferably 200 mm or more, and especially more preferably 300 mm or more.

The fine powder and thin flakes preremoving device 12 may be provided with a suction mouth to be coupled with the first flow channel 1.

### <Fine Powder and Thin Flakes Removing Device>

The aroma collecting apparatus of the present invention is provided with a fine powder and thin flakes removing device communicated with the first flow channel to remove a fine powder and thin flakes.

Any known device may be used as the fine powder and thin flakes removing device, and a cyclone-type separating device (powder separating device) is preferably used.

### <Second Flow Channel>

The aroma collecting apparatus of the present invention is provided with a second flow channel communicated with the fine powder and thin flakes removing device, through which the gas from which a fine powder and thin flakes have been removed can flow.

In the aroma collecting apparatus of the present invention, the diameter (inner diameter) of the second flow channel is not specifically limited and is preferably 30 mm or more from the viewpoint of making more gas flow therethrough, more preferably 50 mm or more, even more preferably 100 mm or more, further more preferably 200 mm or more, and especially preferably 300 mm or more. The second flow channel can be arranged in any desired manner so that the direction of the gas to flow into the aroma compound adsorbing device to be mentioned below can be a desired direction.

### <Aroma Compound Adsorbing Device>

The aroma collecting apparatus of the present invention is provided with an aroma compound adsorbing device communicated with the second flow channel.

The aroma compound adsorbing device has an adsorbent holder that holds an adsorbent therein, and the adsorbent holder has a mesh lid at both ends thereof in the gas flowing direction therethrough. The mesh lid prevents the adsorbent held in the adsorbent holder from leaking out of the aroma compound adsorbing device to enable the gas to flow through the adsorbent.

The mesh lid is a sheet having a desired thickness, and, not specifically limited thereto, the size thereof can be selected to fall within a range capable of preventing the adsorbent from leaking out of the aroma compound adsorbing device. From the viewpoint of securing easy gas flowing therethrough, the mesh lid preferably has an area not smaller than the cross section in the gas flowing direction of the adsorbent holder.

The mesh lid may have a mesh structure wholly or partly. From the viewpoint of securing easy gas flowing therethrough, preferably, a part of the mesh lid corresponding to the cross section of the aroma compound adsorbing device or the adsorbent holder has a mesh structure.

The opening of the mesh lid may be selected in any desired manner within a range within which the adsorbent used may not pass therethrough. Not limited thereto, an example of the opening is within a range of 10 μm to 20 mm.

In the present invention, preferably, the aroma compound adsorbing device includes a part occupied by the adsorbent held in the adsorbent holder therein, that is, the adsorbent part.

In the present invention, the length of the adsorbent part (in the gas flowing direction) is, though not specifically limited thereto but from the viewpoint of reducing the adsorbent resistance, preferably 1000 mm or less, more preferably 700 mm or less, even more preferably 500 mm or less, further more preferably 400 mm or less, even further more preferably 300 mm or less, and especially more preferably 200 mm or less. For example, the length of the adsorbent part may fall within a range of 10 mm to 800 mm, 20 mm to 400 mm, 40 mm to 200 mm, or 50 mm to 100 mm.

The long axis or the diameter of the plane vertical to the gas flowing direction in the adsorbent part (hereinafter they are referred to as a cross-section diameter) is, though not specifically limited, preferably controlled in accordance with the amount of the adsorbent and the length of the adsorbent part. The cross-section diameter of the adsorbent part is, from the viewpoint of securing easy gas flowing, preferably 10 mm or more, more preferably 30 mm or more, even more preferably 50 mm or more, further more preferably 100 mm or more, even further more preferably 200 mm or more, and especially more preferably 300 mm or more.

In the case where the adsorbent amount is desired to be increased, preferably, the cross-section diameter of the adsorbent part is increased and the length of the adsorbent part (in the gas flowing direction) is reduced from the viewpoint of reducing the adsorbent resistance to the gas flowing therethrough.

The adsorbent amount is not limited so far as it can be held in the adsorbent holder. The bulk volume of the adsorbent to be used may be the same as or less than the volume of the adsorbent holder. In other words, the adsorbent may be filled (roughly filled or densely filled) in the adsorbent holder, or the adsorbent holder holding the adsorbent therein may have some void space.

Regarding the arrangement of the aroma compound adsorbing device, the aroma compound adsorbing device is arranged parallel to the installation surface of the aroma collecting apparatus (parallel to the ground contact surface, that is, horizontally) in FIGS. 1 and 2, but the device may also be arranged vertical to the installation surface, or at any other angle thereto. Also, the device may be so arranged that the gas flowing direction into or through the adsorbent can come close to the installation surface of the aroma collecting apparatus, or can go away from the installation surface thereof. In other words, the aroma compound adsorbing device and the gas direction flowing into and through the adsorbent can be substantially opposite to or substantially the same as the direction of gravitational force, or can also be perpendicular thereto, or may be at any other angle.

In the case where the aroma compound adsorbing device is a fluidized-bed column, the column may be so arranged that the bulk volume of the adsorbent to be used is lower than the volume of the adsorbent holder and the gas direction flowing into and through the adsorbent is substantially opposite to the direction of gravitational force. Using a fluidized-bed column can reduce the adsorbent resistance to the gas flowing therethrough.

The aroma compound adsorbing device may be provided with a basket as the adsorbent holder therein. As the basket, there are known a normal-type basket having pores through the side surface thereof, and a sidewall-type basket not having pores through the side surface thereof. Using a sidewall-type basket not having pores through the side surface thereof is preferred from the viewpoint that the gas from which a fine powder and thin flakes have been removed would not leak through the side surface of the basket and therefore the length of the gas flow through the adsorbent can be increased.

### <Gas Flow Generating Device>

The aroma collecting apparatus of the present invention is provided with a gas flow generating device capable of generating a gas flow continuing from the grinding device to the aroma compound adsorbing device. The gas flow generating device 13 can generate a gas flow that continues through the grinding device 11, (the fine powder and thin flakes preremoving device 12), the first flow channel 1, the fine powder and thin flakes removing device 14, the second flow channel 2 and the aroma compound adsorbing device K.

The gas flow generating device may be a blower or a suction aspirator. Examples of a suction aspirator include a suction blower.

### <Guide Path>

Preferably, the aroma collecting apparatus is provided with a guide path 3 in the flow channel of the gas from which a fine powder and thin flakes have been removed (the second flow channel), as branched from this flow channel and communicated with the aroma compound adsorbing device, from the viewpoint that only a part of the gas from which a fine powder and thin flakes have been removed can flow into the guide path and the adsorbent to collect aroma compounds while suppressing the adsorbent resistance. In that manner, the aroma compound adsorbing device may be communicated with the second flow channel via the guide path.

The diameter (inner diameter) of the guide path is, though not specifically limited, preferably 5 mm or more as the inner diameter from the viewpoint of more gas can flow through the guide path, more preferably 15 mm or more, even more preferably 30 mm or more, further more preferably 50 mm or more, even further more preferably 70 mm or more, still further more preferably 100 m or more, still further more preferably 150 mm or more, still further more preferably 200 mm or more, and especially more preferably 300 mm or more.

The guide path 3 may be formed integrally with the second flow channel, or may be detachably connected to the second flow channel. At least a part of the guide path 3 may be fixed to the second flow channel 2 by means of any desired fixing means such as an adhesive tape or screws.

The inlet port 3A of the guide path 3 may be branched at any position of the second flow channel 2. For example, in FIG. 1, the port is arranged at the position extending horizontally (in the right and left direction on the paper) from the second flow channel 2, but may also be arranged in the second flow channel 2 extending in the vertical direction (in the upper direction on the paper) from the gas flow generating device 13.

Preferably, the outlet port 3B of the guide path 3 is connected to the second flow channel 2 so that the gas can be returned back to the second flow channel 2 after the adsorption of the aroma compounds.

The inlet port 3A and the outlet port 3B of the guide path 3 each may be connected to the second flow channel 2 at any angle, and the guide path 3 may be linear, or curved, or may be folded at one or more position.

The material of the guide path 3 is not specifically limited, and may be made of, for example, a metal or a resin.

### <Linear Speed Controlling Device>

Preferably, the aroma collecting apparatus of the present invention is further provided with a linear speed controlling device 4 for controlling the linear speed of the gas from which a fine powder and thin flakes have been removed.

The linear speed controlling device may be a blower or a suction aspirator. Examples thereof include a blower fan and a suction pump.

The position of the linear speed controlling device in the aroma collecting apparatus of the present invention is not specifically limited, and depending on the type thereof, the device may be arranged either upstream or downstream of the flow of the gas flowing through the aroma compound adsorbing device. For example, a blower may be arranged at the upstream, and a suction aspirator may be arranged at the downstream.

The suction aspirator to be used as the linear speed controlling device 4 is preferably one having a higher pumping performance than that of the gas flow generating device 13 from the viewpoint of efficiently collecting aroma compounds.

Preferably, the linear speed controlling device 4 is arranged in the guide path 3. The linear speed controlling device 4 may be arranged at the inlet port 3A of the guide path, or at the outlet port 3B of the guide path.

### EXAMPLES

The present invention is described more specifically with reference to the following Examples and Comparative Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Example 1

In the present invention using an exhaust gas flow from a grinding device, a pressure is given to the inlet port of an aroma compound adsorbing device since an adsorbent is used therein, and consequently, it is desirable whether or not the constitution may impart any load on the gas flow generating device employed in the aroma collecting apparatus of the present invention.

Accordingly in Example 1, a gas flow is introduced into the aroma compound adsorbing device K while the cross-section diameter and the length of the adsorbent part of the aroma compound adsorbing device K, which the aroma collecting apparatus A of the present invention has, are appropriately changed to thereby confirm the presence or absence of a suitable range of the diameter and the length. The aroma compound adsorbing device has mesh lids Ka1 and Ka2, and an adsorbent holder Kb (FIG. 3).

As the adsorbent to be held in the aroma compound adsorbing device K, SP-207 (styrene-divinylbenzene copolymer synthetic adsorbent, manufactured by Mitsubishi Chemical Corporation) was used. As the adsorbent holder to hold the adsorbent (in a roughly filled manner), a cylindrical sidewall-type basket not having pores through the side surface was used.

Next, aromatic compound adsorbing devices, in which the cross-section diameter and the length of the adsorbent part as occupied by the adsorbent held in the aroma compound adsorbing device K were changed as in the following Table 1, were prepared, and for each device, the suction pump arranged at the end of the aroma compound adsorbing device K was driven for gas flowing through the adsorbent held in the aroma compound adsorbing device K. With that, the pressure at the inlet port of each aroma compound adsorbing device and the air flow at the outlet port thereof were measured. In this Example, the cross-section diameter of the adsorbent part is the same as the cross-section diameter (inner diameter) in the air flowing direction of the above-mentioned basket. The aroma compound adsorbing device K was arranged substantially vertically to the ground surface, and the air flowing direction through the adsorbent was substantially the same as the direction of gravitational force.

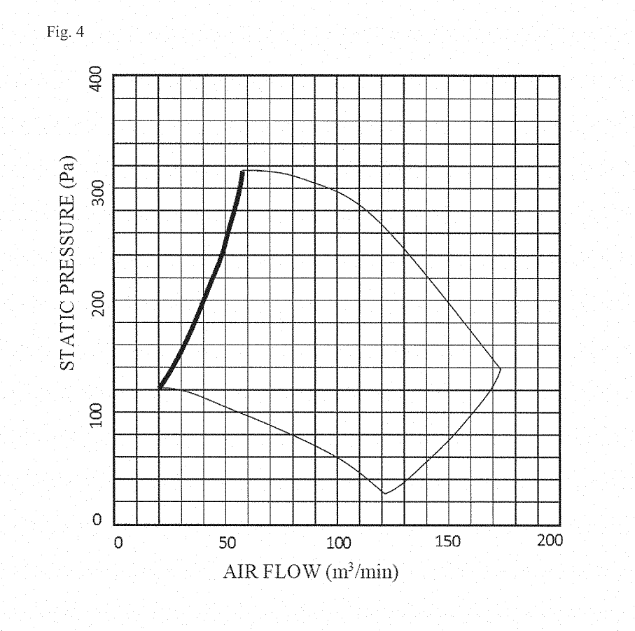

Next, as to whether or not the performance curve (also referred to as airflow-static pressure characteristic curve) of the device would overstep a range of the performance curve of an ordinary blower (gas flow generating device) was confirmed through calculation. This curve is drawn by plotting the relationship between the gas flow pressure and the air volume generated by a blower when the blower motor output is 1.5 to 10 kW. In the case where the performance curve of the tested device does not overstep the range of the performance curve shown in FIG. 4, it suggests that the blower performance is higher than the resistance of the adsorbent within the above-mentioned motor output range and therefore the gas flow generated by the blower can flow through the adsorbent. On the other hand, in the case where the performance curve of the tested blower oversteps toward the left side than the thick line of the curve, it suggests that the output gas amount is still unsatisfactory even under a high pressure, that is, the adsorbent resistance is higher than the blower performance so that a load is given on the blower by the adsorbent.

The results are shown in the following Table 1.

TABLE 1

| | | | | | | | | |
|---|---|---|---|---|---|---|---|---|
| Cross-Section | 20 | 40 | 60 | 80 | 100 | 150 | 200 | 300 |
| Diameter (mm) of | | | | | | | | |
| Adsorbent Part | | | | | | | | |
| Length (cm) of | 75 | 37.5 | 25 | 18.7 | 15 | 10 | 7.5 | 5 |
| Adsorbent Part | | | | | | | | |
| (gas-flowing | | | | | | | | |
| direction) | | | | | | | | |

| | | |
|---|---|---|
| Deviation from | Deviated toward | Fell within the range. |
| Performance | the left. | |
| Curve | | |

The above Table 1 confirms that, owing to the adsorbent resistance to the gas flow, the length of the adsorbent part (in the gas flowing direction) is preferably not more than a predetermined level.

In collecting aroma compounds, it is confirmed that the method preferably includes a step of optimizing the length of the adsorbent part (in the gas flowing direction) depending on the performance of the gas flow generating device employed in the aroma collecting apparatus of the present invention. In addition, it is also confirmed that, in the case where the adsorbent amount is desired to be increased, the cross-section diameter of the adsorbent part is preferably increased without increasing the length of the adsorbent part to thereby reduce the length of the adsorbent part (in the gas flowing direction).

As obvious from the test results, in the case where the performance curve of a system that employs an adsorbent part having a certain length deviates toward the left side from the performance curve of the gas flow generating device that is intended to be used, a linear speed controlling device 4 such as a blower or a suction pump may be additionally arranged near the aroma compound adsorbing device K to generate a gas flow with which the pressure of the gas flow generated by the gas flow generating device 13 can be subsidiary increased, thereby introducing a sufficient gas into the adsorbent.

In addition, it is obvious that, by using a means of reducing the pressure by the adsorbent, for example, by using an adsorbing device where the adsorbent to be held therein is movable, such as a fluidized-bed column, as the aroma compound adsorbing device, or by using any other means of making the gas flow generated by the gas flow generating device 13 partly branch and making the thus-branched gas flow introduced into the adsorbent, sufficient gas flow introduction into the adsorbent is realized only by an ordinary blower even in the absence of the linear speed controlling device 4.

As described above, in the present invention, by appropriately controlling the length of the gas flowing direction through the adsorbent part or by generating a branched or unbranched gas flow or by appropriately controlling the mobility of the adsorbent, in accordance with the gas flow generating device for an ordinary grinding device generally used in the art, a load on an ordinary grinding device can be suppressed more.

### Example 2

Collection of aroma compounds in grinding roasted coffee beans, sensory evaluation of aroma compositions, and load on aroma collecting apparatuses were investigated.

### (1) Aroma Collection

First, an outline of an aroma collecting apparatus A for use in the present Example is shown.

The aroma collecting apparatus A of the present invention has a configuration as shown in FIG. 2 and FIG. 3. Specifically, the aroma collecting apparatus A of the present invention is provided with a grinding device 11, a fine powder and thin flakes preremoving device 12, a first flow channel 1, a gas flow generating device 13, a fine powder and thin flakes removing device 14, a second flow channel 2, and an aroma compound adsorbing device K. In FIG. 2, the aroma compound adsorbing device K is illustrated to be parallel to the installation surface of the aroma collecting apparatus A (parallel to the ground contact surface, that is, horizontally), but herein, the aroma compound adsorbing device K was arranged substantially vertically to the installation surface and the gas flowing direction through the adsorbent part was made substantially the same as the direction of gravitational force.

The aroma collecting apparatus A is provided with a roller mill as the grinding device 11. The grinding device 11 is communicated with the fine powder and thin flakes preremoving device 12, and the other parts can be kept closed during grinding.

The fine powder and thin flakes preremoving device 12 is communicated with the grinding device 11. As the fine powder and thin flakes preremoving device 12, a shaking classifier equipped with a sieve (opening 0.8 mm) is used, and the first flow channel 1 is communicated with the fine powder and thin flakes preremoving device 12 and the gas flow generating device 13. The gas flow generating device 13 is communicated with the first flow channel 1 and the second flow channel 2.

The aroma collecting apparatus A is provided with a suction blower as the gas flow generating device 13. The suction blower can generate a gas flow that continues through the grinding device 11, the fine powder and thin flakes preremoving device 12, the first flow channel 1, the fine powder and thin flakes removing device 14, the second flow channel 2 and the aroma compound adsorbing device K. In addition, the apparatus is provided with a suction pump as the linear speed controlling device 4 downstream the gas flow after the aroma compound adsorbing device K to generate a gas flow along with the gas flow generating device 13.

The aroma collecting apparatus A is provided with a cyclone-type separating device as the fine powder and thin flakes removing device 14.

The first flow channel 1 and the second flow channel 2 each have an inner diameter of 200 mm.

The aroma collecting apparatus A is provided with the aroma compound adsorbing device K in the guide path 3 branched from the second flow channel 2 having an inner diameter of 200 mm. The guide path 3 is so planned that a half of the gas flowing into the second flow channel before the inlet port 3A of the guide path could flow thereinto. The entire amount of the gas having flowed into the guide path 3 flows into the aroma compound adsorbing device K.

As Comparative Example 1, an aroma collecting apparatus a1 was prepared in the same manner as the aroma collecting apparatus A was prepared, except that this apparatus is provided with an aroma compound adsorbing device k1 branching from the top of the grinding device 11, in place of the aroma compound adsorbing device K. The aroma compound adsorbing device k1 is so planned as to have a guide path that guides a gas flow into an adsorbent as branched from the top of the grinding device 11, and an exhaust path to discharge the gas flow having gone out from the adsorbent. The amount of the gas flowing in the guide path branched from the top of the grinding device 11 is so planned as to be the same amount of the gas flowing into the guide path 3 of the aroma collecting apparatus A.

Further, as Comparative Example 2, an aroma collecting apparatus a2 was prepared in the same manner as the aroma collecting apparatus A was prepared, except that this apparatus is provided with an aroma compound adsorbing device k2 branching from the middle of the first flow channel 1, in place of the aroma compound adsorbing device K. The aroma compound adsorbing device k2 is so planned as to have a guide path that guides a gas flow into an adsorbent as branched from the first flow channel 1 having an inner diameter of 200 mm, and an exhaust path to discharge the gas flow having gone out from the adsorbent. The amount of the gas flowing in the guide path is so planned that a half of the gas flowing through the first flow channel 1 before the inlet port thereof (that is, the same amount as that of the gas flowing into the guide path 3 of the aroma collecting apparatus A) can flow therethrough.

The aroma compound adsorbing device K, the aroma compound adsorbing device k1 and the aroma compound adsorbing k2 all are filled with the same amount of the same adsorbent.

Using the aroma collecting apparatus A of the present invention, the aroma collecting apparatus a1 of Comparative Example 1, and the aroma collecting apparatus a2 of Comparative Example 2, aroma compounds from grinding roasted coffee beans were collected.

Specifically, aroma compound were collected according to the following method.

While a gas flow was kept generated in the gas flow generating device 13, roasted coffee beans (L value: 24) was ground at 100 kg/h using a roller mill (grinding device 11) to have a ground size of about 1 mm, thereby giving a crude ground powder of roasted coffee beans containing a fine powder and thin flakes.

Using the aroma collecting apparatus (A, a1 or a2), a part of the fine powder and thin flakes 22 were removed off from the crude powder of roasted coffee beans 23, in a classifier (the fine powder and thin flakes preremoving device 12). The fine powder and the thin flakes 22 not removed through the fine powder and thin flakes preremoving device 12 (mainly containing a fine powder and thin flakes derived from chaff) were made to flow through the first flow channel 1 communicated with the fine powder and thin flakes preremoving device 12, along with the gas (the gas containing aroma compounds 21) inside the grinding device 1 being grinding the roasted coffee beans by the gas flow generated as above. By removing the fine powder and thin flakes 22 from the crude powder of roasted coffee beans 23, a purified ground powder of roasted coffee beans ground into a desired size can be obtained, but this can be stored in a chamber not shown and can be taken out of the aroma collecting apparatus A and stored therein until use thereof for producing coffee products.

The fine powder and thin flakes 22 were removed from the gas containing the aroma compounds 21 emitted from the roasted coffee beans in grinding the roasted coffee beans, and containing the fine powder and thin flakes 22, in the fine powder and thin flakes removing device 14.

The fine powder and the thin flakes 22 removed from the gas was stored in a waste chamber (not shown) communicated with the fine powder and thin flakes removing device 14, and then discarded.

On the other hand, the gas from which a fine powder and thin flakes 22 had been removed was made to flow through the second flow channel 2 communicated with the fine powder and thin flakes removing device 14. The linear speed of the gas flowing through the second flow channel was 4.1 m/s. A half of the gas flowing through the second flow channel 2 flowed into the guide path 3, as so mentioned hereinabove.

During grinding the roasted coffee beans, the gas having flowed into the guide path 3 was then made to flow through the adsorbent held (roughly filled) in the adsorbent holder Kb in the aroma compound adsorbing device (K, k1 or k2), whereby the aroma compounds 21 contained in the gas was adsorbed by the adsorbent.

In all the aroma compound adsorbing devices, the adsorbent and the gas flowing condition were the same, as follows. As the adsorbent holder, a cylindrical sidewall-type basket not having pores through the side was used. For preventing it from cracking, the adsorbent was made to previously absorb pure water, and then filled in the aroma compound adsorbing device before completely dried.

Aroma compound adsorbent: SP-207 (synthetic adsorbent of styrene-divinylbenzene copolymer, manufactured by Mitsubishi Chemical Corporation)

Cross-section diameter of adsorbent part: 100 mm

Linear speed of gas flowing into adsorbent: 2.0 m/s

Length (length in the gas flowing direction) of adsorbent part: 8.0 cm

Amount of adsorbent: 2500 ml

Type of gas: air

Time of grinding and gas flow introduction into adsorbent part: 5 hours

In this Example, the cross-section diameter of the adsorbent part is the same as the cross-section diameter (inner diameter) in the gas flowing direction of the above-mentioned basket.

After the gas flow introduction for 5 hours through each aroma collecting apparatus, 25 kg of propylene glycol (PG) was introduced into the adsorbent in each aroma compound adsorbing device at SV=10 so as to desorb the aroma compounds 21 from the adsorbent. SV (space velocity) means a unit of the volume of the desorbent to be introduced relative to the volume of the resin per hour. The process gave a roasted coffee bean flavor (an aroma composition as a PG solution) containing the aroma compounds having collected in the aroma compound adsorbing device K, k1 or k2. The resultant aroma compositions were referred to as an invention product 1, a comparative product 1 and a comparative product 2.

Here, a half of the gas containing the aroma compounds emitted from 500 kg (grinding for 5 hours at 100 kg/br) of the roasted coffee beans that had been ground was introduced into the adsorbent (as described above, the apparatus was so planned that a half of the gas flowing through the second flow channel 2 could be introduced into the guide path 3 to flow through the adsorbent), and therefore, the adsorbent adsorbed a gas containing the aroma compounds from 250 kg of the roasted coffee beans, and that amount of the aroma compounds was desorbed with PG to give a 25 kg of a PG solution (aroma composition) so that the weight of the aroma composition could be 10% of the weight of the roasted coffee beans that emitted the aroma compounds, and according to the process, the invention product 1, and the comparative products 1 and 2 were prepared.

On the other hand, the aroma compounds of the crude powder of roasted coffee beans were collected through steam distillation to prepare the comparative compound 1. Specifically, 2000 g of the ground roasted coffee beans were put into a 3-liter column, then steam was jetted thereinto from the bottom of the column under atmospheric pressure for 2 hours for steam distillation, and the steam containing the aroma compound(s) coming out from the top of the column was condensed through a condenser tube to give 2000 g of an aqueous solution containing the aroma compounds. Next, the resultant aqueous solution was introduced into 50 ml of an adsorbent (SP-207), then 200 g of PG was introduced into the adsorbent to desorb the adsorbed aroma compounds, thereby giving 200 g of a PG solution as a steam-distillation flavoring composition. This flavoring composition obtained by the steam distillation is referred to as a comparative product 3. Also here, like the invention product 1 and the comparative products 1 and 2, the comparative product 3 was made to have a mass ratio of 10% so as to be directly compared with the invention product 1 and the comparative products 1 and 2 in point of aroma.

### (2) Load on Aroma Collecting Apparatus

After collecting the aroma compounds, the adsorbent from which the aroma compounds had been desorbed was checked for the reusability thereof.

The reusability was confirmed by comparing the pressures of the liquid flowing through the adsorbents (hereinafter each referred to as the adsorbent q1, the adsorbent q2 and the adsorbent Q) held in the aroma compound adsorbing devices (k1, k2 and K, respectively), before and after desorption with PG. Specifically, before and after desorption, the adsorbent holder was purged with ultrapure water and then ultrapure water was introduced into the adsorbent at SV=10, and a ratio of the pressure after desorption to the pressure before desorption was calculated.

As a result, the pressure ratios through the adsorbent q1 and the adsorbent q2 were 10 times and 5 times, respectively, which indicates clogging of these adsorbents. In such a case, the adsorbents must be washed a few times or must be discarded. On the other hand, there was seen little pressure difference in the case of the adsorbent Q, which indicates that no clogging has occurred and it is unnecessary to wash or discard the adsorbent.

The above confirms that the aroma collecting apparatus of the present invention saves time and work for adsorbent regeneration and saves cost thereof. In addition, it is confirmed that the apparatuses of Comparative Examples are unsuitable for industrial use for aroma collection from roasted coffee beans in grinding roasted coffee beans.

### (3) Sensory Evaluation of Aroma Composition

Each of the compositions of the invention product 1 and the comparative products 1 to 3 was added to a substrate (commercially-prepared sugarless black coffee) in an amount shown in Table 2 below, thereby preparing flavored products at Brix 1.0° having a pH of 6.5 before retort sterilization.

Each flavored product was subjected to retort sterilization under a retort sterilization condition at 121° C. for 10 minutes. The resultant flavored product after retort sterilization each had a pH of 5.8.

As the flavored products after retort sterilization, the invention product 1 and the comparative products 1 to 3 were subjected to a sensory evaluation by well-trained 10 panelists. Average sensory evaluation results of the 10 panelists are shown in Table

TABLE 2

| | Aroma Composition | | |
|---|---|---|---|
| | | Amount | |
| Substrate | Category | Added | Evaluation (after retort sterilization) |
| Commercially- | Invention | 0.1% by | An aroma in grinding roasted coffee beans is given at the |
| prepared | Product 1 | mass | top, and a voluminous aroma is given even in the middle |
| Sugarless | | | and later and has a good aftertaste. In addition, the |
| Black Coffee | | | aroma amount considered to be large. |
| | Comparative | | A sweet and roasty aroma not given by the substrate is |
| | Product 1 | | given at the top, but the aroma is weak and is not |
| | | | voluminous. |
| | Comparative | | A dry and woody aroma that may recall chaff is given, |
| | Product 2 | | but the aroma is weak. |
| | Comparative | | The aroma at the top is weak, the aroma amount is small, |
| | Product 3 | | and the aroma lacks a voluminous feel. |

As shown in the above Table 2, the aroma composition of the invention product 1 was, different from the comparative products, an excellent flavor that gives an aroma in grinding roasted coffee beans, that is, an aroma perceivable in grinding roasted coffee beans. This is presumably because, as confirmed in (2), the adsorbents in Comparative Examples clogged by the fine powder and thin flakes and therefore worsened the aroma compound adsorbing efficiency thereof, presenting some differences in the aroma characteristics and the aroma intensity.

### [Example 3] Analytical Values of Flavor Improver of the Invention

In the same manner as in Example 1 using the aroma compound adsorbing device K (namely, a device for adsorbing aroma compounds from the gas from which a fine powder and thin flakes have been removed) but except that ethanol was used in place of propylene glycol in Example 1 as the desorbent, a roasted coffee bean flavor (a coffee flavor improver in the form of an ethanol solution, invention product 2) was produced. The mass ratio of the coffee flavor improver to the roasted coffee beans is 10% like in the case of the PG solution (invention product 1).

The coffee flavor improvers of the invention product 1 prepared in the same manner as in Example 1, and the comparative product 3, and also the invention product 2 produced according to the above-mentioned method were analyzed through GC/MS. Three samples of each of the invention product 1, the invention product 2 and the comparative product 3 were prepared and analyzed here.

As an aroma collecting method, SBSE (stir bar sorptive extraction) was employed. Twister (registered trademark) manufactured by GERSTEL Inc. was put into a vial containing the invention product 1, the invention product 2 or the comparative product 3, and stirring was conducted. Twister (registered trademark) is one produced by coating Stir Bar having a length of about 1.5 cm with PDMS (polydimethylsiloxane), and stirring by Twister (registered trademark) in a vial containing a liquid sample therein can extract the constituent components out of the liquid sample.

The aroma compounds contained in each coffee flavor improver was extracted out and introduced into GC/MS (gas chromatograph/mass spectrometer) using an automatic thermal desorption system.

GC/MS measurement conditions are shown below.

GC/MS: 7890A GC/5975C inert XL MSD (quadrupole mass analyzer) (manufactured by Agilent Technologies Corporation)

Column: InertCap-WAX, 60 m×0.25 mm×inner diameter (I.D.) 0.25 μm (GL Science Inc.)

Carrier gas: He

Mode: constant flow

Column flow rate: 1.4 mL/min

MS: electron-impact ionization (EI mode), 70 eV

Injection method: Gerstel TDU

Initial temperature: 20° C.

Rate: 720° C./min

Final temperature: 260° C.

Holding time: 2 min

Oven initial temperature: 40° C.

Holding time: 5 min

Rate: 5° C./min

Final temperature: 230° C.

Holding time: 20 min

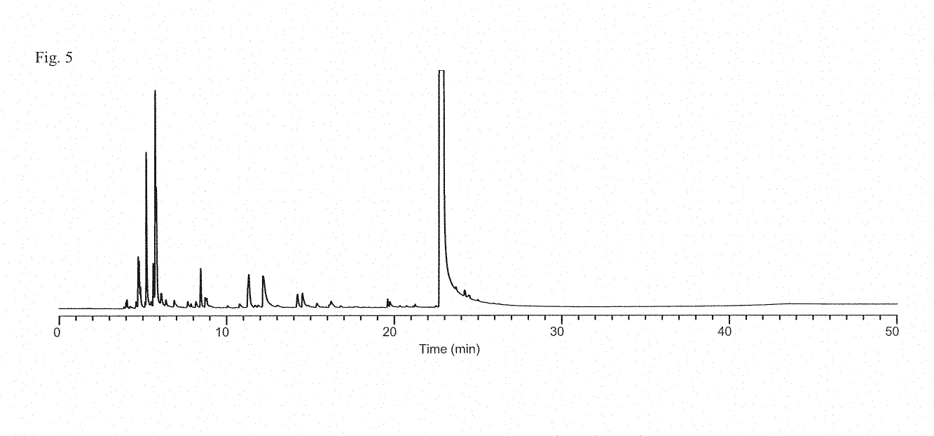

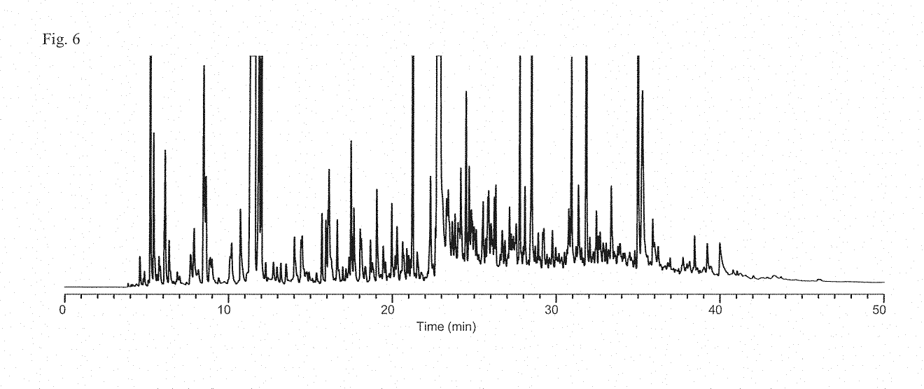

Total ion chromatograms of the aroma collected according to SBSE and analyzed through GC/MS as above are shown in FIGS. 5 and 6. FIG. 5 is a total ion chromatogram of the invention product 1, and FIG. 6 is a total ion chromatogram of the comparative product 3. The peak scaled out at around RT=23 minutes in FIGS. 5 and 6 is a peak attributing to PG used for desorption.

The horizontal axis in FIGS. 5 and 6 indicates a retention time (RT), and the vertical axis therein indicates a peak intensity.

The area ratio of each component contained in each coffee flavor improver was grouped based on a retention index (RI).

Specifically, the components were grouped into those (at the top) whose RI is not more than that for acetoin and those whose RI is more than that for acetoin. RI of acetoin is 1294, and RT of acetoin is about 15 min.

Based on the resultant total ion chromatogram, the percentage of the area (area %) of the components having an RI not more than that for acetoin (top) to the total area of the total ion chromatogram of the aroma composition of each of the invention product 1 (PG solution), the invention product 2 (ethanol solution) and the comparative product 3 (steam-distillation product), and an area % of the components having an RI larger than that for acetoin to the total area of the total ion chromatogram thereof were determined. The results of the three invention products 1 are 89:11, 90:10, and 91:9; the results of the three invention products 2 are 94:6, 93:7, and 96:4; and the results of the three comparative products 3 are 27:73, 29:71, and 30:70. Also, the aroma collected from the substrate (commercially-prepared sugarless black coffee) before retort sterilization through SBSE according to the same method as above was analyzed by GC/MS, and an area % of each component was determined similarly. The results are shown in Table 3 below. The numerical values shown in Table 3 are average values of three samples of each product.

Also based on the total ion chromatogram, an area value (area % to the top) of 2-methylfuran, 2-methylbutyl aldehyde, isovaleraldehyde, 2,5-dimethylfuran and 2-vinylfuran relative to the components having an RI not more than that for acetoin (top) in the coffee flavor improver of each of the invention product 1 and the comparative product 3, and an area % (area % to the middle and later) of 2,6-dimethylpyrazine and 2-ethyl-6-methylpyrazine relative to the components having an RI larger than that for acetoin (middle and later) in the coffee flavor improver were determined. The values of the area % are average values of three samples of each product. The results of the three samples of the invention product 1 are: 2.6%, 2.5%, 2.4% for 2-methylfuran; 5.0%, 5.0%, 4.8% for 2-methylbutyl aldehyde; 3.1%, 3.0%, 3.1% for isovaleraldehyde; 1.2%, 1.8%, 1.7% for 2,5-dimethylpyrazine; 1.8%, 2.3%, 1.8% for 2-ethyl-6-methylpyrazine. The results of the three samples of the invention product 2 are: 1.6%, 1.6%, 1.5% for 2-methylfuran; 1.9%, 1.8%, 1.7% for 2-methylbutyl aldehyde; 1.0%, 1.2%, 11.3% for isovaleraldehyde; 0.9%, 0.5%, 0.7% for 2,5-dimethylpyrazine; 1.3%, 1.1%, 0.8% for 2-ethyl-6-methylpyrazine. Also the aroma collected from the substrate (commercially-prepared sugarless black coffee) before retort sterilization through SBSE was analyzed by GC/MS, and an area % of each component therein was determined similarly. The results are shown in Table 4 and Table 5 below.

TABLE 3

| | | Total of | Total of |
|---|---|---|---|
| | | Components with | Components with |
| | | RI not more than | RI larger than that |
| | Total Area | that for acetoin | for acetoin |
| | Value | [area % (to total | [area % (to total |
| | [area %] | area value)] | area value)] |
| Substrate | 100 | 13 | 87 |
| Invention Product 1 | 100 | 90 | 10 |
| Invention Product 2 | 100 | 93 | 7 |
| Comparative Product 3 | 100 | 29 | 71 |

TABLE 4

| | | | | Invention | Invention | Comparative |
|---|---|---|---|---|---|---|
| RI | Area Value | Compound | Substrate | Product 1 | Product 2 | Product 3 |
| not more than | [area value (to the area value % | 2-methylfuran | 0.04 | 2.4 | 1.6 | 0.1 |
| RI for acetoin | of the top)] | 2-methylbutyl aldehyde | 0.05 | 4.9 | 1.8 | 0.1 |
| | | isovaleraldehyde | 0.04 | 3.1 | 1.2 | 0.1 |
| larger than RI | [area value (to the area value % | 2,5-dimethylpyrazine | 0.5 | 1.6 | 0.7 | 1.4 |
| for acetoin | of the middle and later)] | 2-ethyl-6-methylpyrazine | 0.6 | 2.0 | 1.0 | 2.4 |

TABLE 5

| | | | Invention | Invention | |
|---|---|---|---|---|---|
| RI | Area Value | Compound | Product 1 | Product 2 | Substrate |
| not more than | [area value (to the area value % | 2,5-dimethylfuran | 0.9 | 2.3 | 0.4 |
| RI for acetoin | of the top)] | 2-vinylfuran | 0.8 | 0.8 | 0.3 |
| | | pyridine | 1.9 | 1.2 | 0.5 |
| | | acetoin | 1.9 | 1.9 | 0.6 |
| larger than RI | [area value (to the area value % | 2,6-dimethylpyrazine | 1.2 | 0.5 | 0.4 |
| for acetoin | of the middle and later)] | 2-ethylpyrazine | 1.0 | 0.4 | 0.4 |
| | | 3-ethyl-2,5-dimethylpyrazine | 0.6 | 0.6 | 0.4 |
| | | 2-acetylfuran | 1.1 | 0.6 | 0.5 |
| | | 1-furfurylpyrrole | 0.5 | 0.9 | 0.5 |

Typical examples of the compounds of the invention product 1, as identified through the above-mentioned analysis, are shown below.

### (Invention Product 1)

(1) Compounds Having RI not More than that for Acetoin:

Acetaldehyde, isobutyl aldehyde, acetone, methyl ethyl ketone, ethanol, diacetyl, 2,3-pentanedione, 2,3-hexanedione, N-methylpyrrole, 2-methyl-5-vinylfuran, pyrazine, furfuryl methyl ether, furan, ethyl acetate, 2,5-dimnethylfuran, 3-hexanone, 2-vinylfuran, pyridine, 2-methylfuran, 2-methybutanal, PG acetal, 2-methylbutyl aldehyde, isovaleraldehyde, 2-methylbutyl aldehyde PG acetal, isovaleraldehyde PG acetal, acetoin (RI=1294).

(2) Compounds Having RI Larger than that for Acetoin:

Acetol (RI=1321), furfural, 2-acetylfuran, furfuryl acetate, 3-methylpyridine, 2,5-dimethylpyrazine, 2,6-dimethylpyrazine, 2-ethylpyrazine, 3-hydroxy-2-pentanone, 2,3-dimethylpyrazine, 2-methyl-2-cyclopentenone, 2-ethyl-3-methylpyrazine, 3-ethyl-2,5-dimethylpyrazine, 1-hydroxy-2-butanone, 3-ethylpyridine, 2-ethyl-6-methylpyrazine, 2-ethyl-5-methylpyrazine, 2,3,5-trimethylpyrazine, 2-vinylpyrazine, acetic acid, acetol acetate, furfuryl formate, 2,5-dimethyl-3(2H)-furanone, pyrrole, furyl acetate, acetol propionate, 5-methyl-2-furfural, furfuryl propionate, 2-furfuryl methyl disulfide, γ-butyrolactone, furfuryl alcohol, 1-(1-pyrrolyl)-2-propanone, 1-furfurylpyrrole, dipropylene glycol, phenol.

Typical examples of the compounds of the invention product 2, as identified through the above-mentioned analysis, are the same as those of the invention product 1 (but except PG acetal).

From the above Table 3, it is confirmed that, in the aroma composition of the invention product 1, the content of the components having an RI not more than that for acetoin (top) is larger than the content of the components having an RI larger than that for acetoin (middle and later), and that the aroma balance of the aroma composition owes relatively to the component of the top. Here, the components having an RI not more than that for acetoin are highly volatile and the content thereof is small in the substrate (commercially-prepared sugarless black coffee), and is also small in the aroma composition of the comparative product 3 obtained by steam distillation. The components having an RI larger than that for acetoin are relatively poorly volatile, and the content of the components having an RI not more than that for acetoin is large in the invention product 1 and the invention product 2, but the invention product 1 and the invention product 2 contain in some degree the components having an RI larger than that for acetoin, and consequently, it is confirmed that the invention product 1 and the invention product 2 not only can enhance the aroma at the top but also can give a sufficient voluminous feel to the middle and later.

From the above Table 4 and Table 5, the coffee flavor improver of the invention product 1 and the invention product 2 differs from the substrate and the comparative product 3 in point of the balance of the aroma compounds contained therein. It is known that the content of the top aroma compounds, 2-methylfuran, 2-methylaldehyde and isovaleraldehyde in the invention product 1 and the invention product 2 is larger than that in the substrate. Regarding the aroma compounds in the middle and later, it is confirmed that the content of 2,5-dimethylpyrazine and 2-ethyl-6-methylpyrazine is larger than that in the substrate. From the above, it can be said that the comparative product 3 can enhance mainly the flavor in the middle and later of the substrate which, however, intrinsically contains a relatively large content of aroma compounds in the middle and later, while on the other hand, it can be said that the invention product 1 and the invention product 2 can enhance the aroma in a well-balanced manner from the top to the middle and later.

### [Example 4] Effect of Addition of Flavor Improver (PG Solution) of the Invention to Coffee Drinks, and Analytical Values

Flavored products (before retort sterilization and after retort sterilization) using the invention product 1 or the comparative product 3 prepared in the same manner as in Example 2 and the substrate (commercially-prepared sugarless black coffee) were analyzed through GC/MS. Three samples of each flavored product using the invention product 1 or the comparative product 3 were prepared and analyzed.

From the resultant total ion chromatogram, an area % of the components having an RI not more than that for acetoin (top) and an area % of the components having an RI larger than that for acetoin (each area % relative to the substrate) were determined in the same manner as Example 3, for the commercially-prepared sugarless black coffee (substrate), the sugarless black coffee added with the invention product 1 (PG solution) and the sugarless black coffee added with comparative product 3 (steam-distillation product), before and after retort sterilization. The results are shown in Table 6 below.

Also from the resultant total ion chromatogram, an area % (area % relative to the substrate) of 2-methylfuran, 2-methylbutyl aldehyde, isovaleraldehyde, 2-ethyl-6-methylpyrazine and 2,5-dimethylpyrazine was determined in the same manner as in Example 3. The results are shown in Table 7 below.

TABLE 6

| | | | Total of components with | | | |
|---|---|---|---|---|---|---|
| | | | RI not more than that for | | Total of components | |
| | | | acetoin (RT is shorter | | with RI larger than that for | |
| | | | than 16 min, Top) | | acetoin (RT is 16 to 60 min) | |
| Flavored | | Added | [area % (to substrate)] | | [area % (to substrate)] | |
| Product | Substrate | Product | value of each sample | average | value of each sample | average |
| Before retort | Commercially- | — | — | 100 | — | 100 |
| sterilization | prepared black | Invention | 112 | 111 | 106 | 105 |
| | coffee | product 1 | 110 | | 105 | |
| | | | 110 | | 104 | |
| | | Comparative | 98 | 101 | 113 | 113 |
| | | product 3 | 102 | | 112 | |
| | | | 102 | | 113 | |
| After retort | | — | — | 100 | — | 100 |
| sterilization | | Invention | 108 | 107 | 104 | 104 |
| | | product 1 | 106 | | 104 | |
| | | | 107 | | 103 | |
| | | Comparative | 95 | 96 | 102 | 103 |
| | | product 3 | 98 | | 104 | |
| | | | 94 | | 102 | |

TABLE 7

| | | | | | | Components with | |
|---|---|---|---|---|---|---|---|
| | | | Components with RI not | | | RI larger than that for | |
| | | | more than that for acetoin (Top) | | | acetoin (Middle and later) | |
| | | Added | | 2-methylbutyl | | 2-ethyl-6- | 2,5- |
| Substrate | Sterilization | Product | 2-methylfuran | aldehyde | isovaleraldehyde | methylpyrazine | dimethylpyrazine |
| Commercially- | Before retort | — | 100 | 100 | 100 | 100 | 100 |
| prepared | sterilization | Invention | 122 | 118 | 125 | 118 | 114 |
| sugarless black | | product 1 | | | | | |
| coffee | | Comparative | 100 | 98 | 102 | 120 | 121 |
| | | product 3 | | | | | |
| | After retort | — | 100 | 100 | 100 | 100 | 100 |
| | sterilization | Invention | 117 | 118 | 118 | 116 | 113 |
| | | product 1 | | | | | |
| | | Comparative | 103 | 102 | 103 | 118 | 119 |
| | | product 3 | | | | | |

The above Table 6 confirms that the flavored products (before retort sterilization) using the coffee flavor improver of the invention product 1 enjoy the aroma-enhancing effect at the top and in the middle and later. In particular, it is confirmed that the content of 2-methylfuran, 2-methylbutyl aldehyde and isovaleraldehyde (aroma compounds with RI not more than that for acetoin) and the content of 2-ethyl-6-methylpyrazine and 2,6-diethylpyrazine (aroma compounds with RI larger than that for acetoin) in the flavored products increased to be more than those in the substrate (commercially-prepared sugarless black coffee). On the other hand, the comparative product 3 enhanced only the aroma almost in the middle and later, and therefore could hardly be said to have increased the aroma in a well-balanced manner from the top to the middle and later.

In addition, the flavored products (after retort sterilization) using the coffee flavor improver of the invention product 1 also enjoy the aroma-enhancing effect at the top and in the middle. In particular, it is confirmed that the content of 2-methylfuran, 2-methylbutyl aldehyde, isovaleraldehyde, 2-ethyl-6-methylpyrazine and 2,6-diethylpyrazine in the flavored products increased to be more than that in the substrate (commercially-prepared sugarless black coffee). Accordingly, it is confirmed that the aroma at the top and the middle still remained after retort sterilization. On the other hand, the comparative product 3 enhanced only the aroma in the middle and later, and therefore could hardly be said to have increased the aroma in a well-balanced manner from the top to the middle and later.

Accordingly, from the above Table 6, it is known that the flavored products using the coffee flavor improver of the invention product 1 are well improved to have an enhanced aroma at the top and in the middle and later in a well-balanced manner before and after retort sterilization, and owing to this, the products make users feel not only the aroma emitted in grinding roasted coffee beans but also a voluminous flavor thereof especially in the middle and later, that is, the products give an extremely good flavor from the top to the last in a well-balanced manner.

From the above Table 7, it is known that, in the flavored products using the coffee flavor improver of the invention product 1, the content of the components of interest, 2-methylfuran, 2-methylbutyl aldehyde and isovaleraldehyde is increased by about 20% than that in the substrate, before retort sterilization and after retort sterilization. In addition, it is also known that the content of 3-ethylpyridine and 2,5-dimethylpyrazine is increased by about 20% compared to that in the substrate.

### [Example 5] Effect of Addition of Coffee Flavor Improver (PG Solution and Ethanol Solution) of the Invention to Coffee Drinks

In the same manner as above except that an aroma compound adsorbing device K was used and a middle chain fatty acid triglyceride (manufactured by Kao Corporation, Coconard ML) (hereinafter referred to as MCT) was used in place of propylene glycol in Example 2 as the desorbent, as a comparative example, a roasted coffee bean aroma composition 1 (MCT solution) was produced to be a comparative product 4. The ratio by mass of the coffee aroma composition relative to the roasted coffee beans is 10% like in the case of propylene glycol (invention product 1). MCT is a vegetable oil generally used as a solvent in the field of food and drink.

As another comparative example, the gas flow in the guide path 3 was introduced into 25 kg of MCT held in a 30-liter tank to trap the aroma compounds 21 in MCT, thereby giving a roasted coffee bean aroma composition 2 (MCT solution) as a comparative product 5. Also for the comparative product 5, the gas containing aroma compounds from 250 kg of roasted coffee beans was made to flow through 25 kg of soybean oil for 5 hours, like the cases of the invention products 1 and 2 and comparative product 4, thereby giving a coffee aroma composition having a coffee flavor improver content of 10% by weight relative to the weight of the roasted coffee beans from which the aroma compounds were emitted.

Next, the invention product 1, the invention product 2, the comparative product 4 and the comparative product 5 were separately added to two types of commercially-prepared coffee drink (commercially-prepared sugarless black coffee and commercially-prepared coffee with milk) prepared as a substrate here in the manner as indicated in Table 8, then subjected to retort sterilization in the same manner as in Example 4 to produce coffee drinks of invention products (drinks A to F) and coffee drinks of comparative products (drinks a to d). Twenty well-trained panelists tested these coffee drinks for sensory evaluation relative to a control (that is, an unflavored commercially-prepared coffee drink) in point of the flavor of the coffee drinks of the invention products and the comparative product as compared with that of the control. The results are shown in Table 8. In the sensory evaluation, the following scores were given to the tested samples based on the standards mentioned below. Further, Table 9 shows average comments given by the panelists.

### (Sensory Evaluation Score)

### (1) Regarding Preference

5: Noticeably preferred to the control.
3: Relatively preferred to the control.
1: Preferred like the control.
0: Had an unfavorable flavor different from coffee, and therefore not preferred to the control.

### (2) Regarding the Flavor at the Top

5: Noticeably enhanced over the control, and gave a strong sweet and roasty aroma.
3: Somewhat enhanced over the control, and gave a sweet and roasty aroma.
1: Same level as that of the control.
0: Poor than the control, or had an unfavorable flavor different from coffee.

### (3) Regarding the Flavor in the Middle

5: Noticeably enhanced over the control, and gave a voluminous aroma and a good aftertaste.
3: Gave a somewhat enhanced voluminous aroma and a good aftertaste.
1: Same level as that of the control.
0: Poor than the control, or had an unfavorable flavor different from coffee.

TABLE 8
Black Coffee

| | Desorbent | Added Amount (% by mass) | | | | |
|---|---|---|---|---|---|---|
| | or | | | | Comparative | |
| Added | Collection | Invention Product | | | Product | |
| Product | Liquid | Drink A | Drink B | Drink C | Drink a | Drink b |
| Invention | PG | 0.1 | — | 0.05 | — | — |
| Product 1 | | | | | | |
| Invention | EtOH | — | 0.1 | 0.05 | — | — |
| Product 2 | | | | | | |
| Comparative | MCT | — | — | — | 0.1 | — |
| Product 4 | | | | | | |
| Comparative | MCT | — | — | — | — | 0.1 |
| Product 5 | | | | | | |
| Sensory | preference | 4.5 | 3.5 | 4.5 | 2.0 | 2.0 |
| Evaluation | top | 4.2 | 4.2 | 4.6 | 3.9 | 3.7 |
| Score | middle | 4.5 | 3.8 | 4.2 | 2.5 | 2.2 |
| | and later | | | | | |

Coffee with milk

| | Desorbent | Added Amount (% by mass) | | | | |
|---|---|---|---|---|---|---|
| | or | | | | Comparative | |
| Added | Collection | Invention Product | | | Product | |
| Product | Liquid | Drink D | Drink E | Drink F | Drink c | Drink d |
| Invention | PG | 0.1 | — | 0.05 | — | — |
| Product 1 | | | | | | |
| Invention | EtOH | — | 0.1 | 0.05 | — | — |
| Product 2 | | | | | | |
| Comparative | MCT | — | — | — | 0.1 | — |
| Product 4 | | | | | | |
| Comparative | MCT | — | — | — | — | 0.1 |
| Product 5 | | | | | | |
| Sensory | preference | 4.3 | 3.6 | 4.4 | 2.3 | 2.4 |
| Evaluation | top | 4.0 | 4.3 | 4.5 | 3.8 | 3.8 |
| Score | middle | 4.2 | 3.7 | 4.5 | 2.2 | 2.2 |
| | and later | | | | | |

In the Tables, the numerical value is % by mass relative to the total mass of the coffee.
EtOH means ethanol.

TABLE 9

| Drink | Sensory Evaluation Comments |
|---|---|
| Drink A | At the top, the drink gave a sweeter and more roasty flavor like that given in grinding |
| | roasted coffee beans, than the substrate, and subsequently to it, the drink gave an |
| | enhanced, long lasting voluminous and mild flavor and had a clean finish. |
| Drink B | At the top, the drink gave an extremely sweeter and more roasty flavor like that given in |
| | grinding roasted coffee beans, than the substrate, and subsequently, the drink gave a |
| | relatively enhanced, long lasting voluminous flavor and had a clean finish. |
| Drink C | At the top, the drink gave a sweeter and more roasty flavor like that given in grinding |
| | roasted coffee beans, than the substrate, and subsequently, the drink gave an enhanced, |
| | long lasting voluminous and mild flavor and had a clean finish. |
| Drink D | At the top, the drink gave a sweeter and more roasty flavor like that given in grinding |
| | roasted coffee beans, than the substrate, and subsequently, the drink gave a long lasting |
| | voluminous flavor and the milk-like flavor thereof was somewhat richer than the |
| | substrate. |
| Drink E | At the top, the drink gave a sweeter and more roasty flavor like that given in grinding |
| | roasted coffee beans, than the substrate, and subsequently, the drink gave a long lasting |
| | voluminous flavor and the milk-like flavor thereof was enhanced to have a lightly |
| | refreshing feel. |
| Drink F | At the top, the drink gave a sweeter and more roasty flavor like that given in grinding |
| | roasted coffee beans, than the substrate, and subsequently, the drink gave a long lasting |
| | voluminous flavor and the milk-like flavor thereof was enhanced to have a lightly |
| | refreshing feel. |
| Drink a | Though the drink gave an enhanced aroma at the top, the flavor thereof in the middle |
| | and later was poor, and the drink was not given so much enhanced voluminous flavor. |
| Drink b | Though the drink gave an enhanced aroma at the top, the flavor thereof in the middle |
| | and later was poor, and the drink was not given so much enhanced voluminous flavor. |
| Drink c | Though the drink gave an enhanced aroma at the top, the flavor thereof in the middle |
| | and later was poor, and the drink was not so much enhanced or improved in point of |
| | milky flavor and voluminous flavor. |
| Drink d | Though the drink gave an enhanced aroma at the top, the flavor thereof in the middle |
| | and later was poor, and the drink was not so much enhanced or improved in point of |
| | milky flavor and voluminous flavor. |

As shown in Table 8 and Table 9, it is confirmed by the evaluation that the comparative drinks are somewhat preferred to the substrate but the invention drinks noticeably improved the flavor of the substrate and enhanced the coffee preference.

The comparative drinks are recognized to enjoy a top flavor improving effect but are poor in enhancement in the flavor in the middle and later, that is, the overall preference of the coffee drinks was not increased so much. On the other hand, the invention drinks enjoy a higher top flavor improving effect than the comparative drinks and, in addition, the flavor improving effect thereof in the middle and later is high (for example, in point of the voluminous flavor, milk-like flavor, rich flavor, freshening flavor, and good aftertaste in the last), and the overall preference of the coffee drinks of the invention products are thereby noticeably improved.

From the above, it is confirmed that the coffee flavor improver of the present invention using propylene glycol or ethanol as a solvent can improve and enhance not only the top flavor but also the flavor in the middle and later, and therefore can make coffee drinks have a more natural and preferred flavor as a whole.

### [Example 6] Analytical Data of Coffee Drinks Added with Coffee Flavor Improver of the Invention

Various sugarless black coffee drinks and milk-added coffee drinks obtained in Example 5 were analyzed through gas chromatography for the aroma compounds contained in these drinks, in the same manner as in Example 3. The results are shown in Table 10. Table 11 and Table 12 show main constituent compounds in the drinks C and F of the present invention that had increased relative to the substrate (except 2-methylfuran, 2-methylbutyl aldehyde, isovaleraldehyde, 2,5-dimethylfuran, 2-vinylfuran, 2,5-dimethylpyrazine and 2-ethyl-6-methylpyrazine described in Examples 2 and 3), and the increase rate thereof (ratio to the substrate of 100%).

TABLE 10

| | | Total of | | Total of | |
|---|---|---|---|---|---|
| | | Components | | Components with | |
| | | with RI not more | | RI larger than | |
| | | than that for | | that for acetoin | |
| | | acetoin (RT is less | | (RT is 16 to | |
| | | than 16 min: top) | | 60 min) | |
| | | [area % (to | | [area % (to | |
| | | substrate)] | | substrate)] | |
| | | value | | value | |
| Flavored | Added Product | of each | | of each | |
| Product | (or Substrate) | product | average | product | average |
| Commercially- | Substrate with | — | 100 | — | 100 |
| prepared | no additive | | | | |
| sugarless black | Drink A | 108 | 110 | 105 | 107 |
| coffee | (PG) | 112 | | 107 | |
| | | 110 | | 107 | |
| | Drink B | 112 | 112 | 102 | 104 |
| | (EtOH) | 115 | | 105 | |
| | | 110 | | 104 | |
| | Drink C | 112 | 112 | 106 | 106 |
| | (PG + EtOH) | 114 | | 109 | |
| | | 110 | | 104 | |
| Commercially- | Substrate with | — | 100 | — | 100 |
| prepared coffee | no additive | | | | |
| with milk | Drink D | 108 | 109 | 104 | 106 |
| | (PG) | 110 | | 106 | |
| | | 110 | | 106 | |
| | Drink E | 112 | 111 | 102 | 103 |
| | (EtOH) | 111 | | 105 | |
| | | 111 | | 102 | |
| | Drink F | 112 | 112 | 103 | 105 |
| | (PG + EtOH) | 113 | | 106 | |
| | | 109 | | 105 | |

TABLE 11
Black Coffee Drink

| | | [area % (to substrate)] | |
|---|---|---|---|
| | | | invention |
| Compound | | substrate | drink |
| RI is not more than | Furan | 1 | 1.20 |
| that for acetoin | 2,5-Dimethylfuran | 1 | 1.48 |
| | 3-Hexanone | 1 | 1.34 |
| | 2-Vinylfuran | 1 | 1.51 |
| | Pyridine | 1 | 1.21 |
| RI is larger than that | 2,6-Dimethylpyrazine | 1 | 1.06 |
| for acetoin | 2-Ethylpyrazine | 1 | 1.08 |
| | 3-Ethylpyridine | 1 | 1.46 |
| | 2-Ethyl-5-methylpyrazine | 1 | 1.07 |
| | 2-Ethyl-3-methylpyrazine | 1 | 1.06 |
| | 2-Acetylfuran | 1 | 1.07 |
| | 2-Furfuryl methyl disulfide | 1 | 1.10 |

TABLE 12
Coffee Drink with milk

| | | [area % (to substrate)] | |
|---|---|---|---|
| | | | invention |
| Compound | | substrate | drink |
| RI not more than | Ethyl acetate | 1 | 1.46 |
| that for acetoin | 2-Methylbutyl aldehyde | 1 | 1.09 |
| | Isovaleraldehyde | 1 | 1.07 |
| | 2,5-Dimethylfuran | 1 | 1.42 |
| | 3-Hexanone | 1 | 1.35 |
| | 2-Vinylfuran | 1 | 1.18 |
| RI larger than that | 2,6-Dimethylpyrazine | 1 | 1.09 |
| for acetoin | 3-Ethylpyridine | 1 | 1.06 |
| | 2-Ethyl-5-methylpyrazine | 1 | 1.06 |
| | 2-Ethyl-3-methylpyrazine | 1 | 1.02 |
| | 2,6-Diethylpyrazine | 1 | 1.18 |
| | 3-Ethyl-2,5-dimethylpyrazine | 1 | 1.04 |
| | 2-Furfuryl methyl disulfide | 1 | 1.03 |
| | 1-Furfurylpyrrole | 1 | 1.03 |

As shown in Table 10, it is confirmed that, in the coffee drinks of the invention products of both sugarless black coffees and coffees with milk, the compounds with RI not more than that for acetoin (aroma compounds at the top) and the compounds with RI larger than that for acetoin (aroma compounds in the middle and later) increased to be more than those in the substrate, and it can be said that the data herein support the sensory evaluation results of Example 5 concluding that not only the flavor at the top but also the flavor in the middle and later was enhanced.

Table 11 and Table 12 show examples of compounds that increased in the coffee drinks prepared by adding the same amount of the invention product 1 or the invention product 2 to a coffee drink substrate (that is, drinks C and F) to be more than those in the coffee drink substrate, and as in these, some aroma compounds greatly increased in the top (for example, 2,5-dimethylfuran, 3-hexanone, 2-vinylfuran, ethyl acetate), and some other aroma compounds increased also in the middle and later (for example, 3-ethylpyridine, 2,6-diethylpyridine).

As described above, the coffee flavor improver of the present invention, for which a specific solvent is used for the aroma compounds emitted from roasted coffee beans in grinding the roasted coffee beans, can exhibit a remarkable effect of improving the flavor not only at the top but also in the middle and later, and therefore can provide a well-balanced flavor improving effect that could not be experienced before in the art.

### REFERENCE SIGNS LIST

1 First Flow Channel
2 Second Flow Channel
3 Guide Path
3A Inlet Port of Guide Path
3B Outlet Port of Guide Path
4 Linear Speed Controlling Device
11 Grinding Device
12 Fine Powder and Thin Flakes Preremoving Device
13 Gas Flow Generating Device
14 Fine Powder and Thin Flakes Removing Device
21 Aroma Compounds
22 Fine Powder and Thin Flakes
23 Crude Powder of Roasted Coffee Beans
24 Exhaust Gas
K Aroma Compound Adsorbing Device
Ka1, Ka2 Mesh Lid
Kb Adsorbent Holder
k1 Aroma Compound Adsorbing Device Used in Comparative Example 1
k2 Aroma Compound Adsorbing Device Used in Comparative Example 2

1. A method for producing an aroma composition from roasted coffee beans, which comprises:
grinding roasted coffee beans to give a crude ground powder of roasted coffee beans that contains a fine powder and thin flakes, and comprises:
removing the fine powder and thin flakes from a gas that contains aroma compounds emitted from the roasted coffee beans in grinding the roasted coffee beans and contains the fine powder and thin flakes,
an adsorption step of introducing the gas from which the fine powder and thin flakes have been removed into an adsorbent to thereby make the aroma compounds adsorbed by the adsorbent, and
a collection step of collecting the aroma compounds from the adsorbent to prepare an aroma composition containing the aroma compounds, and in which:
the adsorbent is held in an adsorbent holder in an aroma compound adsorbing device, and the adsorbent holder has a mesh lid at both ends thereof in the gas flowing direction therethrough.

2. The method for producing an aroma composition from roasted coffee beans according to claim 1, wherein removing the fine powder and thin flakes from the crude ground powder of roasted coffee beans is carried out prior to the step of removing the fine powder and thin flakes from the gas.

3. The method for producing an aroma composition from roasted coffee beans according to claim 1, wherein the step of removing the fine powder and thin flakes is carried out in the fine powder and thin flakes removing device.

4. The method for producing an aroma composition from roasted coffee beans according to claim 1, wherein the gas flow is formed using a gas flow generating device.

5. The method for producing an aroma composition from roasted coffee beans according to claim 1, wherein:
in the flow channel for the gas from which the fine powder and thin flakes have been removed, a guide path that branches from the flow channel and is communicated with the aroma compound adsorbing device is provided, and
only a part of the gas from which the fine powder and thin flakes have been removed is made to flow through the guide path and the adsorbent to collect the aroma compounds.

6. The method for producing an aroma composition from roasted coffee beans according to claim 1, wherein the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel.

7. The method for producing an aroma composition from roasted coffee beans according to claim 1, wherein the aroma compounds are desorbed from the adsorbent using an organic solvent in the collection step.

8. The method for producing an aroma composition from roasted coffee beans according to claim 7, wherein the organic solvent is ethanol or propylene glycol.

9. The method for producing an aroma composition from roasted coffee beans according to claim 1, wherein the linear speed of the gas flowing into the adsorbent is within a range of 0.1 to 35.0 m/s.

10. The method for producing an aroma composition from roasted coffee beans according to claim 1, wherein the gas flowing direction is substantially an opposite direction to the direction of gravitational force.

11. The method for producing an aroma composition from roasted coffee beans according to claim 1, wherein the aroma compound adsorbing device is a fluidized-bed column that holds the adsorbent therein.

12. The method for producing an aroma composition from roasted coffee beans according to claim 1, which includes controlling the linear speed of the gas flowing into the adsorbent.

13. The method for producing an aroma composition from roasted coffee beans according to claim 12, wherein the linear speed of the gas flowing into the adsorbent is controlled using a blower or a suction pump.

14. A food or drink containing an aroma composition produced according to the production method of claim 1.

15. An apparatus for collecting aroma from roasted coffee beans, which is provided with:
a device for grinding roasted coffee beans,
a first flow channel which is communicated with the grinding device and through which a gas can flow, the gas containing aroma compounds emitted in grinding the roasted coffee beans and containing a fine powder and thin flakes,
a fine powder and thin flakes removing device communicated with the first flow channel,
a second flow channel which is communicated with the fine powder and thin flakes removing device and through which the gas, from which a fine powder and thin flakes have been removed, can flow,
an aroma compound adsorbing device communicated with the second flow channel, and
a gas flow generating device that generates a gas flow continuing from the grinding device to the aroma compound adsorbing device, and in which:
the aroma compound adsorbing device has an adsorbent holder that holds an adsorbent therein, and the adsorbent holder has a mesh lid at both ends thereof in the gas flowing direction therethrough.

16. The apparatus for collecting aroma from roasted coffee beans according to claim 15, which is further provided with a guide path branched from the second flow channel, and in which the guide path is communicated with the aroma compound adsorbing device.

17. The apparatus for collecting aroma from roasted coffee beans according to claim 15, which is further provided with a fine powder and thin flakes preremoving device between the grinding device and the first flow channel.

18. The apparatus for collecting aroma from roasted coffee beans according to claim 15, wherein the gas flowing direction through the adsorbent is substantially an opposite direction to the direction of gravitational force.

19. The apparatus for collecting aroma from roasted coffee beans according to claim 15, wherein the aroma compound adsorbing device is a fluidized-bed column that holds the adsorbent therein.

20. The apparatus for collecting aroma from roasted coffee beans according to claim 15, which is further provided with a linear speed controlling device for controlling the linear speed of the gas from which the fine powder and thin flakes have been removed.

21. The apparatus for collecting aroma from roasted coffee beans according to claim 15, wherein the linear speed controlling device is a blower or a suction pump.

22. The apparatus for collecting aroma from roasted coffee beans according to claim 15, wherein the diameter of the cross section of the adsorbent part held in the adsorbent holder is 10 mm or more.

23. The apparatus for collecting aroma from roasted coffee beans according to claim 15, wherein the length in the gas flowing direction of the adsorbent part held in the adsorbent holder is 1000 mm or less.
